(19) United States
(12) Patent Application Publication
(10) Pub. No.: US 2013/0044267 A1
(43) Pub. Date: Feb. 21, 2013

(54) OPTICAL FILM FOR 3D IMAGE DISPLAY, 3D IMAGE DISPLAY DEVICE, AND 3D IMAGE DISPLAY SYSTEM

(71) Applicants: Makoto ISHIGURO, Kanagawa (JP); Shinichi MORISHIMA, Kanagawa (JP)

(72) Inventors: Makoto ISHIGURO, Kanagawa (JP); Shinichi MORISHIMA, Kanagawa (JP)

(73) Assignee: FUJIFILM Corporation

(21) Appl. No.: 13/471,092

(22) Filed: May 14, 2012

(30) Foreign Application Priority Data
Aug. 19, 2011 (JP) 2011-179732

(51) Int. Cl. G02F 1/1335

(52) U.S. Cl. 349/15; 349/194

(57) ABSTRACT

Disclosed is an optical film for 3D image display devices, comprising at least an optically-anisotropic layer formed of a composition that comprises, as the main ingredient thereof, a polymerizable liquid crystal, and a polarizing film having an absorption axis in the direction at 45° to an arbitrary side, wherein the total of retardation along the thickness direction at a wavelength of 550 nm Rth(550) of all the members including the optically-anisotropic layer disposed on one face of the polarizing film is from −100 to 100 nm.

### CROSS-REFERENCE TO RELATED APPLICATIONS

The present application claims the benefit of priority from Japanese Patent Application No. 2011-179732, filed on Aug. 19, 2011, the contents of which are herein incorporated by reference in their entirety.

### BACKGROUND OF THE INVENTION

1. Field of the Invention

The present invention relates to an optical film for 3D image display, a 3D image display device and a 3D image display system, having an optically-anisotropic layer with high-definition orientation patterns, easy to produce and improved in display performance free from trouble of brightness reduction and in lightfastness.

2. Background Art

A 3D image display device of displaying a 3D image requires an optical member that converts a right-eye image and a left-eye image, for example, into circularly-polarized images in the opposite directions. For example, as the optical member, used is a patterned retardation film in which multiple domains differing from each other in slow axis and retardation are regularly arranged in plane.

Regarding use of a patterned retardation film, for example, WO2010/090429A2 proposes an optical film for which an alignment layer is used for patterning and in which the optically-anisotropic layer contains a rod-shaped liquid crystal, and proposes use of the optical film as a patterned retarder for 3D display. Japanese Patent 4547641 proposes formation of an optically-anisotropic layer by forming multiple grooves on the outermost surface of a substrate through patterning, for example, with a mold, then applying a liquid-crystal material containing a liquid-crystal monomer on the patterned surface of the substrate and polymerizing the monomer thereon. However, these documents do not disclose adjusting Re of the material constituting the patterned retardation film and Rth of all the materials constituting the patterned retardation film.

### SUMMARY OF THE INVENTION

However, the inventors found that, when the patterned retardation plate produced by the use of a liquid-crystal material was actually used in a 3D image display device, the brightness in oblique directions lowered, or that is, the viewing angle characteristics worsened.

An object of the invention is to provide a novel optical film for 3D image display devices that contributes toward improving the viewing angle characteristics of 3D image display devices, and to provide a 3D image display device and a 3D image display device system using the film.

The means for achieving the object are as follows:

<1> An optical film for 3D image display devices, comprising at least:

an optically-anisotropic layer formed of a composition that comprises, as the main ingredient thereof, a polymerizable liquid crystal, and

a polarizing film having an absorption axis in the direction at 45° to an arbitrary side, wherein

the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane,

the optically-anisotropic layer is disposed on one face of the polarizing film,

the total of retardation in-plane at a wavelength of 550 nm Re(550) of all the members including the optically-anisotropic layer disposed on one face of the polarizing film that are disposed in a domain corresponding to at least one of the first and second retardation domains is from 110 to 160 nm, and

the total of retardation along the thickness direction at a wavelength of 550 nm Rth(550) of all the members including the optically-anisotropic layer disposed on one face of the polarizing film is from −100 to 100 nm.

<2> An optical film for 3D image display devices, comprising at least:

an optically-anisotropic layer formed of a composition that comprises, as the main ingredient thereof, a polymerizable liquid crystal, and

a polarizing film having an absorption axis in the direction at 90° to an arbitrary side, wherein

the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane;

the optically-anisotropic layer is disposed on one face of the polarizing film,

the total of retardation in-plane at a wavelength of 550 nm Re(550) of all the members including the optically-anisotropic layer disposed on one face of the polarizing film that are disposed in a domain corresponding to at least one of the first and second retardation domains is from 110 to 160 nm, and

the total of retardation along the thickness direction at a wavelength of 550 nm Rth(550) of the optically-anisotropic layer and all the members disposed on the opposite surface of the optically-anisotropic layer to the surface thereof on which the polarizing film is disposed is from −100 to 100 nm.

<3> The optical film according to <1> or <2>, wherein the in-plane slow axis of the first and second retardation domains and the transmission axis of the polarizing film are at an angle of ±45°.
<4> The optical film according to any one of <1>-<3>, comprising, on the opposite surface of the optically-anisotropic layer to the surface thereof having the polarizing film thereon, a layer that contains a UV absorbent.
<5> The optical film according to any one of <1>-<4>, wherein the polymerizable liquid crystal is a polymerizable rod-shaped liquid crystal.
<6> The optical film according to <5>, wherein the polymerizable rod-shaped liquid crystal is fixed in a horizontally-aligned state.
<7> The optical film according to any one of <1>-<6>, comprising a polymer film of which retardation along the thickness-direction at a wavelength of 550 nm Rth(550) is from −200 to 0 nm, between the optically-anisotropic layer and the polarizing film.
<8> The optical film according to any one of <1>-<7>, comprising an antireflection layer on the opposite surface of the optically-anisotropic layer to the surface thereof having the polarizing film thereon, and comprising, between the optically-anisotropic layer and the antireflection layer, a polymer film of which retardation along the thickness-direction at a wavelength of 550 nm Rth(550) is from −200 to 0 nm.
<9> A 3D image display device comprising at least:

a display panel to be driven on the basis of an image signal, and

an optical film of any one of <1>-<8> disposed on the viewing side of the display panel.

<10> The 3D image display device according to <9>, wherein the display panel comprises a liquid-crystal cell.
<11> The 3D image display device according to <10>, wherein the optical film is an optical film of any one of <1> and <3>-<8>, and the liquid-crystal cell is a TN-mode cell.
<12> The 3D image display device according to <10>, wherein the optical film is an optical film of any one of <2>-<8>, and the liquid-crystal cell is a VA-mode or IPS-mode cell.
<13> A 3D image display system comprises at least:

a 3D image display device of any one of <9>-<12>, and

a polarizing plate disposed on the viewing side of the 3D image display device, which visualizes a 3D image through the polarizing plate.

According to the invention, it is possible to provide a novel optical film for 3D image display devices that contributes toward improving the viewing angle characteristics of 3D image display devices, and to provide a 3D image display device and a 3D image display device system using the film.

### BRIEF DESCRIPTION OF THE DRAWINGS

FIG. 1 is a schematic cross-sectional view of one example of the optical film for 3D image display devices of the invention.

FIG. 2 is a schematic view of one example of the relationship between a polarizer film and an optically-anisotropic layer.

FIG. 3 is a schematic view of one example of the relationship between a polarizer film and an optically-anisotropic layer.

FIG. 4 is a schematic top view of one example of the patterned optically-anisotropic layer in the invention.

FIG. 5 shows schematic cross-sectional views of other examples of the optical film of the invention.

FIG. 6 shows schematic cross-sectional views of some constitutional examples of the 3D image display device of the invention.

FIG. 7 is a schematic view showing one example of the cross section of a flexographic plate for use for patterning.

FIG. 8 is a schematic view showing one example of a method of flexographic printing.

FIG. 9 is a view showing the optical characteristics evaluation result of the retardation plate produced in Examples.

FIG. 10 shows schematic views of examples of an exposure mask.

### DESCRIPTION OF REFERENCE NUMERALS AND SIGNS

10 Retardation Plate
12 Patterned Optically-Anisotropic Layer
12a First Retardation Domain
12b Second Retardation Domain
a In-Plane Slow Axis
b In-Plane Slow Axis
14 Transparent Support
16 Polarizing Film
31 Flexographic Plate
32 Parallel Alignment layer (or Vertical Alignment layer)
33 Vertical Alignment layer Liquid for Patterning (or parallel alignment layer liquid for patterning)
40 Flexographic Printer
41 Impression Cylinder
42 Printing Pressure Roller
43 Anilox Roller
44 Doctor Blade
p Absorption Axis of Polarizing Plate

### DETAILED DESCRIPTION OF THE INVENTION

The invention is described in detail hereinunder. In this description, the numerical range expressed by the wording “a number to another number” means the range that falls between the former number indicating the lowermost limit of the range and the latter number indicating the uppermost limit thereof. First described are the terms used in this description.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program. When a film to be analyzed is expressed by a monoaxial or biaxial index ellipsoid, Rth(λ) of the film is calculated as follows. This measuring method may be used for measuring the mean tilt angles at the alignment layer interface and at the opposite interface of rod-like liquid crystal molecules in an optically anisotropic layer.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film. In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR. Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (B):

$$Re ( θ ) = [ nx - \frac{ny + nz}{\begin{matrix}\sqrt{{\{ ny sin ( {sin}^{- 1} ( \frac{sin ( - θ )}{nx} ) ) )}^{2}} + \\ {( nz cos ( {sin}^{- 1} ( \frac{sin ( - θ )}{nx} ) ) )}^{2}\end{matrix}} ] \times \frac{d}{cos ( {sin}^{- 1} ( \frac{sin ( - θ )}{nx} ) )} \qquad ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (B):

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR. In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below: cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

In this description, “visible light” means from 380 nm to 780 nm. Unless otherwise specifically defined in point of the wavelength in measurement in this description, the wavelength in measurement is 550 nm.

In this description, the angle (for example, “90°”, etc.) and the relational expressions thereto (for example, “perpendicular”, “parallel”, “45°”, “90°”, etc.) should be so interpreted as to include the error range generally acceptable in the technical field to which the invention belongs. For example, this means within a range of a strict angle±less than 10°, and the error from the string angle is preferably at most 5°, more preferably at most 3°.

### 1. Optical Film for 3D Image Display Device:

The invention relates to an optical film for 3D image display devices, containing at least a patterned optically-anisotropic layer formed of a composition that comprises, as the main ingredient thereof, a polymerizable liquid crystal, and a polarizing film.

The present inventors variously studied the reasons causing the reduction in brightness of a 3D display device containing a patterned circularly-polarizing plate with a patterned optically-anisotropic layer of a liquid-crystal composition and a polarizing film when being observed in oblique directions, and found that one of the reasons was Rth of various members including the patterned optically-anisotropic layer as disposed outside on the viewing side than the polarizing film. The patterned optically-anisotropic layer formed of a liquid-crystal composition is generally used in such a condition that the layer is stacked on a support such as a polymer film or the like to support it and with a protective film or the like to protect it. The polymer film or the like to be used as the support has some retardation, and it may be necessary to adjust Re of the laminate as a whole to a suitable Re range for forming circularly-polarized images, etc. It is difficult to form the optically-anisotropic layer, the polymer film or the like having some Re but having no Rth, and therefore, in general, they have some Rth. The optically-anisotropic layer formed of a liquid-crystal composition and the polymer film to be laminated thereon have some Rth, and Rth of the laminate may often be large positively or negatively a whole. In particular, the patterned retardation plate for use in 3D display devices is a member to be disposed outside on the viewing side of the display panel in the device, and therefore requires a protective member for protecting the panel from being deteriorated through exposure to outside light and also an antireflection member or the like for preventing outside light from reflecting on the panel, and it is indispensable to laminate a polymer film or the like on the plate by which Rth of the resulting laminate may often too much increase. Such a high Rth of the laminate member as a whole is one reason of reducing the brightness in oblique directions.

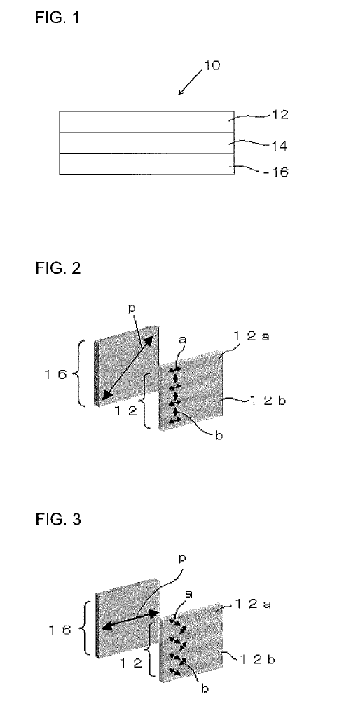

The present inventors have made further investigations and, as a result, found that when the total of Rth of the members including the patterned optically-anisotropic layer disposed outside on the viewing side than the polarizing film is from −100 to 100 nm, then the depression in the brightness in oblique direction can be relieved, and even in oblique directions, 3D image display at a sufficient brightness is possible. As a result of assiduous studies made by the present inventors, it was found also that, even when the same members were disposed to have the same level of Rth, the degree of influence thereof on the viewing angle characteristics varied depending on the absorption axis direction of the polarizing film. Concretely, it was found that, in the embodiment shown in FIG. 2 (the embodiment wherein the absorption axis of the polarizing film was at 45° relative to an arbitrary side (that is, the absorption axis of the polarizing film was along the 45°- or 135°-direction with respect to the horizontal direction of the display panel face, 0°), Rth of all of the members, which were disposed outside on the viewing side than the polarizing film, affected the viewing angle characteristics of the panel; and on the other hand, in the embodiment shown in FIG. 3 (or the embodiment wherein the absorption axis of the polarizing film was at 90° relative to an arbitrary side (that is, absorption axis of the polarizing film was along the 0°- or 90°-direction with respect to the horizontal direction of the display panel, 0°), Rth of the member(s), which was disposed between the polarizing film and the optically-anisotropic layer, hardly affected but Rth of all of the members including, the optically-anisotropic layer and any member(s) which was disposed further outside of the layer on the viewing side, affected the viewing angle characteristics.

In the invention,

in the embodiment where the polarizing film has an absorption axis in the direction of 45° relative to an arbitrary side, the total of retardation along the thickness-direction at a wavelength of 550 nm Rth(550) of all the members including the optically-anisotropic layer disposed on one face of the polarizing film is from −100 to 100 nm, preferably from −60 to 60 nm, more preferably from −60 to 20 nm, and

in the embodiment where the polarizing film has an absorption axis in the direction of 90° relative to an arbitrary side, the total of retardation along the thickness-direction at a wavelength of 550 nm Rth(550) of the optically-anisotropic layer and all the members disposed on the opposite side of the optically-anisotropic layer to the side thereof on which the polarizing film is disposed is from −100 to 100 nm, preferably from −60 to 60 nm, more preferably from −60 to 20 nm, whereby the depression in the brightness in oblique directions is relieved.

“Arbitrary side” means the long side or the short side of a rectangular film; however, for any other film than a rectangular one, the film is approximated to a rectangular film and its side is specified. For an oval film, the arbitrary side may be a long side or a short side; for a circular film, the arbitrary side may be one side of the cubic formed of four tangent lines to the circle. In the invention, the direction of the in-plane slow axis is not required to be strictly at 45° or 90°, but accepts the above-mentioned error range.

Of the liquid-crystal materials for use for forming a patterned optically-anisotropic layer, some have a positive birefringence (for example, rod-shaped liquid crystals), and others have a negative birefringence (for example, discotic liquid crystals). For example, when a patterned optically-anisotropic layer having a positive Rth and formed of a rod-shaped liquid crystal material showing a positive birefringence is combined with a support of a polymer film having a negative Rth, then their Rth may be counterbalanced to each other so that Rth of the laminate as a whole falls within the above-mentioned range.

The optical film for 3D image display devices of the invention has a patterned optically-anisotropic layer which contains a first retardation domain and a second retardation domain differing from each other in at least one of the in-plane slow axis direction and retardation in-plane thereof and in which the first and second retardation domains are alternately arranged in plane. The optical film for 3D image display devices of the invention is disposed outside on the viewing side of a display panel (in case where the display panel has a polarizing film on the viewing side, the optical film is disposed further outside the polarizing film on the viewing side of the display panel), and the polarized image having passed through the first and second retardation domains of the retardation plate is visualized as a right-eye or left-eye image via polarized glasses. Accordingly, it is desirable that the first and second retardation domains both have the same shape so that the right and left images are not be unequal, and it is also desirable that their configurations are equal and symmetric.

In the invention, the total of retardation in-plane at a wavelength of 550 nm Re(550) of all the members including the optically-anisotropic layer disposed on one face of the polarizing film that are disposed in a domain corresponding to at least one of the first and second retardation domains is from 110 to 160 nm, or that is, substantially λ/4. In this, of all the members mentioned above, the total Re(550) of all the members disposed in a domain corresponding to at least one of the first and second retardation domains may be substantially λ/4. For example, one may be substantially λ/4 while the other may be substantially ¾λ (concretely from 375 nm to 435 nm). Needless-to-say, the two may be λ/4, and in such a case, the slow axes must be perpendicular to each other.

Possible embodiments are summarized in the following Table. The retardation domains A and B in the Table each mean all the members disposed in the domain corresponding to the first and second retardation domains, respectively.

TABLE 1

| | | | | Relationship |
|---|---|---|---|---|
| | | | | to |
| | | | | Absorption |
| | | | Relationship | Axis of |
| | Retardation | Retardation | of | Linearly |
| | Domain A | Domain B | In-Plane Slow | Polarizing |
| Embodiment | Re(550) | Re(550) | Axes | Film |
| First | λ/4 | λ/4 | perpendicular | ±45° |
| Embodiment | | | to each other | |
| Second | λ/4 | 3λ/4 | parallel to each | ±45° |
| Embodiment | | | other | |
| Third | 0 | λ/2 | — | ±45° |
| Embodiment | | | | |
| Fourth | 3λ/4 | λ/4 | parallel to each | ±45° |
| Embodiment | | | other | |
| Fifth | λ/2 | 0 | — | ±45° |
| Embodiment | | | | |

FIG. 1 shows a schematic cross-sectional view of one example of the optical film for 3D image display devices of the invention. The optical film 10 shown in FIG. 1 comprises a polarizing film 16, an optically-anisotropic layer 12, and a transparent support 14 to support the an optically-anisotropic layer 12, and the optically-anisotropic layer 12 is a patterned optically-anisotropic layer of which the first and second retardation domains 12a and 12b are equally and symmetrically disposed in an image display device. In one example of the optically-anisotropic layer, retardation in-plane of the first and second retardation domains 12a and 12b is around λ/4 each, and the two domains have in-plane slow axes a and b, respectively, perpendicular to each other. In this example, the optically-anisotropic layer 12 is so disposed that the in-plane slow axes a and b of the first and second retardation domains 12a and 12b are intersect with the transmission axis P of the polarizing film 16 at ±45°, as shown in FIG. 2 and FIG. 3. The configuration makes it possible to separate right-eye and left-eye circularly-polarized images from each other. Further lamination with a λ/2 plate may widen the viewing angle.

Using an optically-anisotropic layer where retardation in-plane of one of the first and second retardation domains 12a and 12b is λ/4 and retardation in-plane of the other is 3λ/4 also makes it possible to separate those circularly-polarized images from each other. Further, right-eye and left-eye linearly-polarized images may be separated from each other by using an optically-anisotropic layer where retardation in-plane of one of the first and second retardation domains 12a and 12b is λ/4 and retardation in-plane of the other is 3λ/4.

Using an optically-anisotropic layer where retardation in-plane of one of the first and second retardation domains 12a and 12b is λ/2 and retardation in-plane of the other is 0 followed by laminating it with a support of which retardation in-plane is λ/4, in such a manner that their slow axes are parallel to or perpendicular to each other also makes it possible to separate circularly-polarized images from each other.

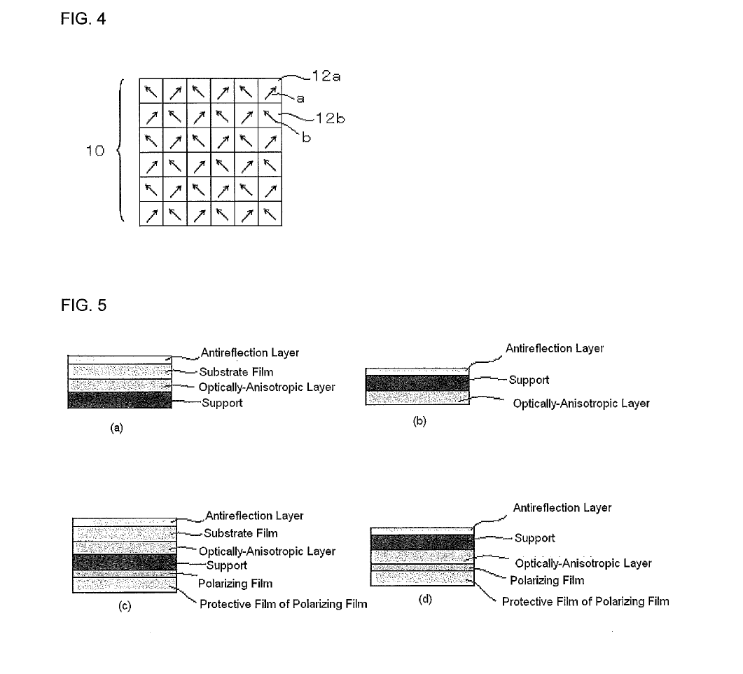

The shape and the configuration pattern of the first and second retardation domains 12a and 12b are not limited to the embodiments shown in FIG. 2 and FIG. 3 where stripe-like patterns are alternately arranged. As in FIG. 4, rectangular patterns may be arranged like a lattice.

The optical film may contain any other member. In the example shown in FIG. 1, an alignment layer may be disposed between the transparent support 14 and the optically-anisotropic layer 12, and a surface film containing an antireflection layer may be disposed further outside the optically-anisotropic layer 12. A protective film for the polarizing film 16 may be disposed between the transparent support 14 and the polarizing film 16. On the back of the polarizing film 16, a protective film may be further disposed. As described above, in case where the display panel has a polarizing film on the surface thereof on the viewing side, the optical film of the invention may not have a polarizing film, and may be in such an embodiment where the optical film is combined with the polarizing film of the display panel to thereby exhibit the function of separating circularly-polarized images, etc. The details of these members usable here are described hereinunder. FIGS. 5(a) to (d) show schematic cross-sectional views of other examples of the optical film of the invention.

Re(550) of the transparent support 14 is not specifically defined. In case where the surface film does not have a support or in case where a surface layer is not disposed, Re(550) of the transparent support 14 is preferably from −5 to 10 nm, more preferably from −2 to 7 nm, even more preferably from 0 to 5 nm. Rth(550) of the transparent support 14 is preferably from −200 to 0 nm, more preferably from −170 to 0 nm, even more preferably from −150 to 0 nm.

In case where the surface film has a support, Re(550) of the transparent support 14 is preferably from −5 to 10 nm, more preferably from −2 to 7 nm, even more preferably from 0 to 5 nm. Rth(550) of the transparent support 14 is preferably from −200 to 0 nm, more preferably from −170 to 0 nm, even more preferably from −150 to 0 nm.

The optically-anisotropic layer 12 is formed of a composition comprising, as the main ingredient thereof, a polymerizable liquid crystal. Examples of the polymerizable liquid crystal include a polymerizable rod-shaped liquid crystal. In an embodiment where a rod-shaped liquid crystal is sued, preferably, the rod-shaped liquid crystal is aligned horizontally. In this description, “horizontal alignment” means that the major axis of the rod-shaped liquid crystal is parallel to the layer plane. The configuration does not require a strict parallel state, and in this description, the horizontal alignment means that the tilt angle to the horizontal plane is less than 10 degrees. The details of the rod-shaped liquid crystal and the method for forming the optically-anisotropic layer using the rod-shaped liquid crystal are described below.

In an embodiment where retardation in-plane of the first and second retardation domains 12a and 12b is around λ/4 each, preferably, the in-plane slow axes a and b are at an angle of ±45° to the transmission axis of the polarizing film. In this description, the configuration does not require a state of strictly ±45°, but preferably, any one of the first and second retardation domains 12a and 12b is at from 40 to 50° and the other is preferably at from −50 to −40°.

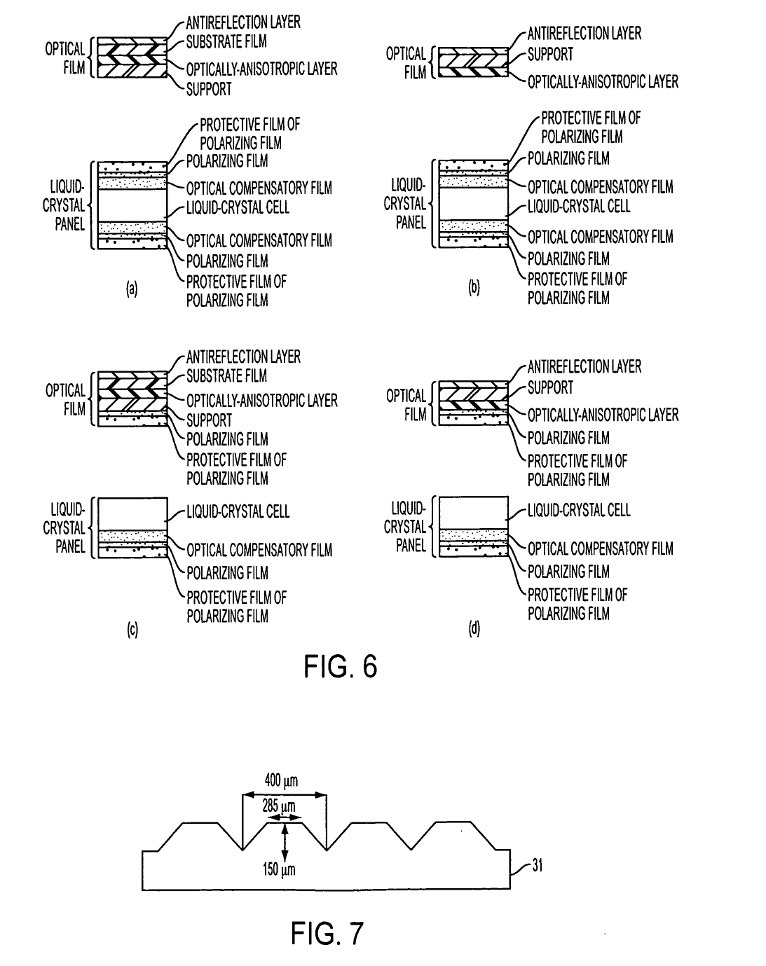

It is unnecessary that Re of the optically-anisotropic layer 12 is λ/4 by itself, but preferably, the sum total of Re of all the members including the optically-anisotropic layer 12 disposed on one surface of the polarizing film 16, for example, in the embodiment of FIG. 6(a), the sum total of Re of all the polarizer protective film, the support, the optically-anisotropic layer and the substrate film, in the embodiment of FIG. 6(b), the sum total of Re of all the polarizer protective film, the optically-anisotropic layer and the support, in the embodiment of FIG. 6(c), the sum total of Re of all the support, the optically-anisotropic layer and the substrate film, and in the embodiment of FIG. 6(d), the sum total of Re of the optically-anisotropic layer and the support, is from 110 to 160 nm, more preferably from 120 to 150 nm, even more preferably from 125 to 145 nm.

On the other hand, when the optical film is disposed on a display panel, Rth of the member disposed outside on the viewing side than the polarizing film has some influence on the viewing angle characteristics of the panel, and therefore, the absolute value of Rth is preferably smaller; and concretely, Rth is preferably from nm to 100 nm, more preferably from −60 to 60 nm, even more preferably from −60 to 20 nm. However, as described above, even when the same member is disposed to have the same level of Rth, the degree of influence thereof on the viewing angle characteristics varies depending on the transmission axis direction of the polarizing film. Concretely, in the embodiment of FIG. 2, or that is, in the embodiment where the transmission axis direction of the polarizing film is at 45° or 135° when the horizontal direction of the display panel face is at 0°, Rth of all the members disposed outside on the viewing side than the polarizing film has some influence on the viewing angle characteristics of the panel, but on the other hand, in the embodiment of FIG. 3, or that is, in the embodiment where the transmission axis direction of the polarizing film is at 0° or 90° when the horizontal direction of the display panel face is at 0°, Rth of the member disposed between the polarizing film and the optically-anisotropic layer has little influence but Rth of all the members of the optically-anisotropic layer and those disposed further outside it on the viewing side has some influence on the viewing angle characteristics.

Examples of the embodiments of FIG. 6(a) to (d) are described with reference to the configuration of FIG. 2. In the embodiment of FIG. 6(a), the sum total of Rth of all the polarizer protective film, the support, the optically-anisotropic layer and the substrate film, in the embodiment of FIG. 6(b), the sum total of Rth of all the polarizer protective film, the optically-anisotropic layer and the support, in the embodiment of FIG. 6(c), the sum total of Rth of all the support, the optically-anisotropic layer and the substrate film, and in the embodiment of FIG. 6(d), the sum total of Rth of the optically-anisotropic layer and the support is preferably from −100 to 100 nm, more preferably from −60 to 60 nm, even more preferably from −60 to 20 nm; and with reference to the configuration of FIG. 3, in the embodiments of FIGS. 6(a) and (c), the sum total of Rth of all the optically-anisotropic layer and the substrate film, and in the embodiments of FIGS. 6(b) and (d), the sum total of Rth of the optically-anisotropic layer and the support is preferably from −100 nm to 100 nm, more preferably from −60 to 60 nm, even more preferably from −60 to 20 nm.

### 2. 3D Image Display Device and 3D Image Display System:

The invention also relates to a 3D image display device and a 3D image display system having the optical film of the invention. The optical film of the invention is disposed on the viewing side of a display panel, and has the function of converting the image that the display panel displays into polarized images such as right-eye and left-eye circularly-polarized images or linearly-polarized images, etc. The viewers view these images via polarizing plate such as circularly-polarized or linearly-polarized glasses or the like to recognize them as a 3D image.

In the invention, no limitation is given to the display panel. For example, the display panel may be a liquid-crystal display panel containing a liquid-crystal layer, or an organic EL display panel containing an organic EL layer, or a plasma display panel. In any embodiment, various possible configurations can be employed. A transmission-mode liquid-crystal panel or the like has a polarizing film for image display on the surface thereof on the viewing side, and in this, therefore, the optical film of the invention may be used in such a manner that the polarizing film thereof serves as the polarizing film on the viewing side of the liquid-crystal display panel. Needless-to-say, the optical film of the invention may have a polarizing film separately from the liquid-crystal panel, but in such a case, the optical film is preferably disposed so that the absorption axis of the polarizing film of the polarizer contained in the optical film former is parallel to the absorption axis of the polarizing film of the liquid-crystal panel.

FIG. 6(a) to (d) show schematic cross-sectional views of configuration examples of 3D image display devices having the optical film of the invention shown in FIG. 5(a) to (d), respectively, and a liquid-crystal panel as the display panel; however, the invention is not limited to these configurations. In the drawings, the relative relationship of the thickness between the layers does not always correspond to the relative relationship of the thickness between the layers of actual liquid-crystal display devices. The embodiments of FIG. 6(a) to (d) are transmission-mode configurations, in which a backlight is disposed on the rear side of the liquid-crystal cell and a polarizing film is disposed between the backlight and the liquid-crystal cell.

The configuration of the liquid-crystal cell is not specifically defined. Here, any liquid-crystal cell having an ordinary configuration can be employed. For example, the liquid-crystal cell contains a pair of substrates placed opposite to each other but not shown, and a liquid-crystal cell sandwiched between the pair of substrates, and may optionally contain a color filter layer, etc. The driving mode of the liquid-crystal cell is not also specifically defined, and various modes are employable here, including twisted nematic (TN), super-twisted nematic (STN), vertical alignment (VA), in-plane switching (IPS), optically compensated bend cell (OCB) and the like modes. In the TN mode, in general, the transmission axis of the polarizing film is disposed at 45° or 135° relative to the horizontal direction, 0° on the panel surface, and therefore preferably, the TN-mode liquid-crystal panel is combined with the retardation plate shown in FIG. 2. In the VA-mode and IPS-mode, in general, the transmission axis of the polarizing film is disposed at 0° or 90° relative to the horizontal direction 0° on the panel surface, and therefore preferably, the VA-mode or IPS-mode liquid-crystal panel is combined with the retardation plate of the embodiment shown in FIG. 3.

Various members used in the optical film for 3D image display devices of the invention are described in detail hereinunder.

### Optically-Anisotropic Layer:

The optically-anisotropic layer in the invention is a patterned optically-anisotropic layer which contains a first retardation domain and a second retardation domain differing from each other in at least one of the in-plane slow axis direction and retardation in-plane thereof and in which the first and second retardation domains are alternately disposed in plane. One example is an optically-anisotropic layer in which the first and second retardation domains each have Re of around λ/4, and the in-plane slow axes of those domains are perpendicular to each other. In another example of the optically-anisotropic layer, one domain has Re of around λ/4 and the other has Re of around ¾λ, and the in-plane slow axes of those domains are parallel to each other. In still another example thereof, one domain has Re of around λ/2 (concretely, from 250 nm to 290 nm) and the other has Re of 0.

The optically-anisotropic layer may have Re of around λ/4 by itself, and in such a case, Re(550) of the layer is preferably from 110 to 160 nm, more preferably from 120 to 150 nm, even more preferably from 125 to 145 nm, still more preferably from 125 to 140 nm. Preferably, Rth(550) of the optically-anisotropic layer is from 55 to 80 nm, more preferably from 60 to 75 nm.

According to the invention any polymerizable liquid crystal(s) is used for preparing the optically anisotropic layer. Examples thereof include polymerizable rod-like liquid crystals. The layer is preferably prepared by aligning rod-like liquid crystal horizontally and then curing the alignment state thereof. Examples of the rod-like liquid crystal compound include azomethine compounds, azoxy compounds, cyanobiphenyl compounds, cyanophenyl esters, benzoate esters, cyclohexanecarboxylic acid phenyl esters, cyanophenylcyclohexane compounds, cyano-substituted phenylpyrimidine compounds, alkoxy-substituted phenylpyrimidine compounds, phenyldioxane compounds, tolan compounds and alkenylcyclohexylbenzonitrile compounds. Not only the low-molecular-weight, liquid-crystalline compound as listed in the above, high-molecular-weight, liquid-crystalline compound may also be used. Examples of the high-molecular-weight liquid-crystalline compound include those obtained by polymerization of any low-molecular weight rod-like liquid crystal having any polymerizable group(s). preferable examples of the low-molecular weight rod-like liquid crystal having any polymerizable group(s) include rod-like liquid crystal compounds represented by formula (I) below.

Q¹-L¹-A¹-L³-M-L⁴-A²-L²-Q² Formula (I)

In the formula, Q¹ and Q² each independently represent a reactive group; L¹, L², L³ and L⁴ each independently represent a single bond or a divalent linking group; A¹ and A² each independently represent a C₂₋₂₀ spacer group; and M represents a mesogen group.

Examples of the compound represented by formula (I) include, but are not limited to, those describe below. The compound represented by formula (I) may be prepared according to the process described in JP-A-11-513019 (WO97/00600).

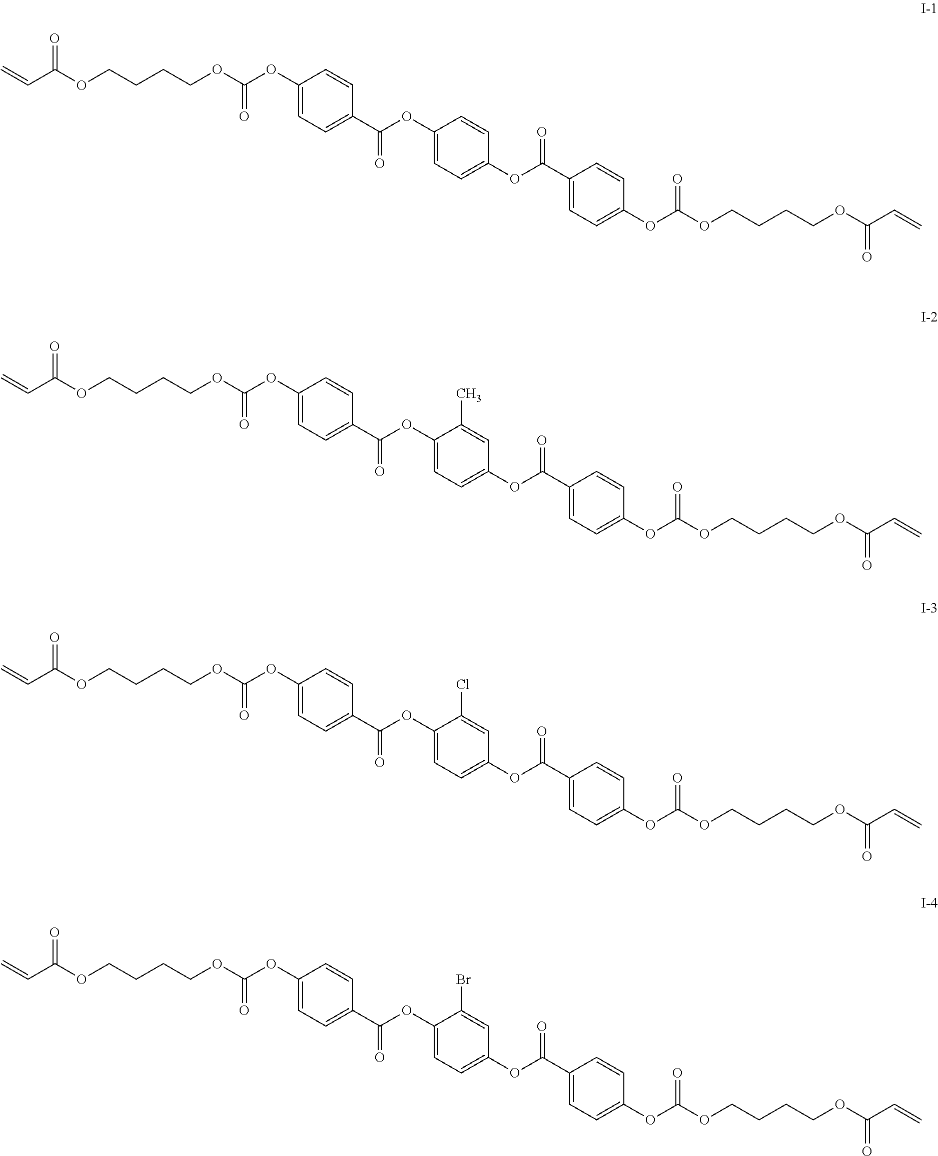

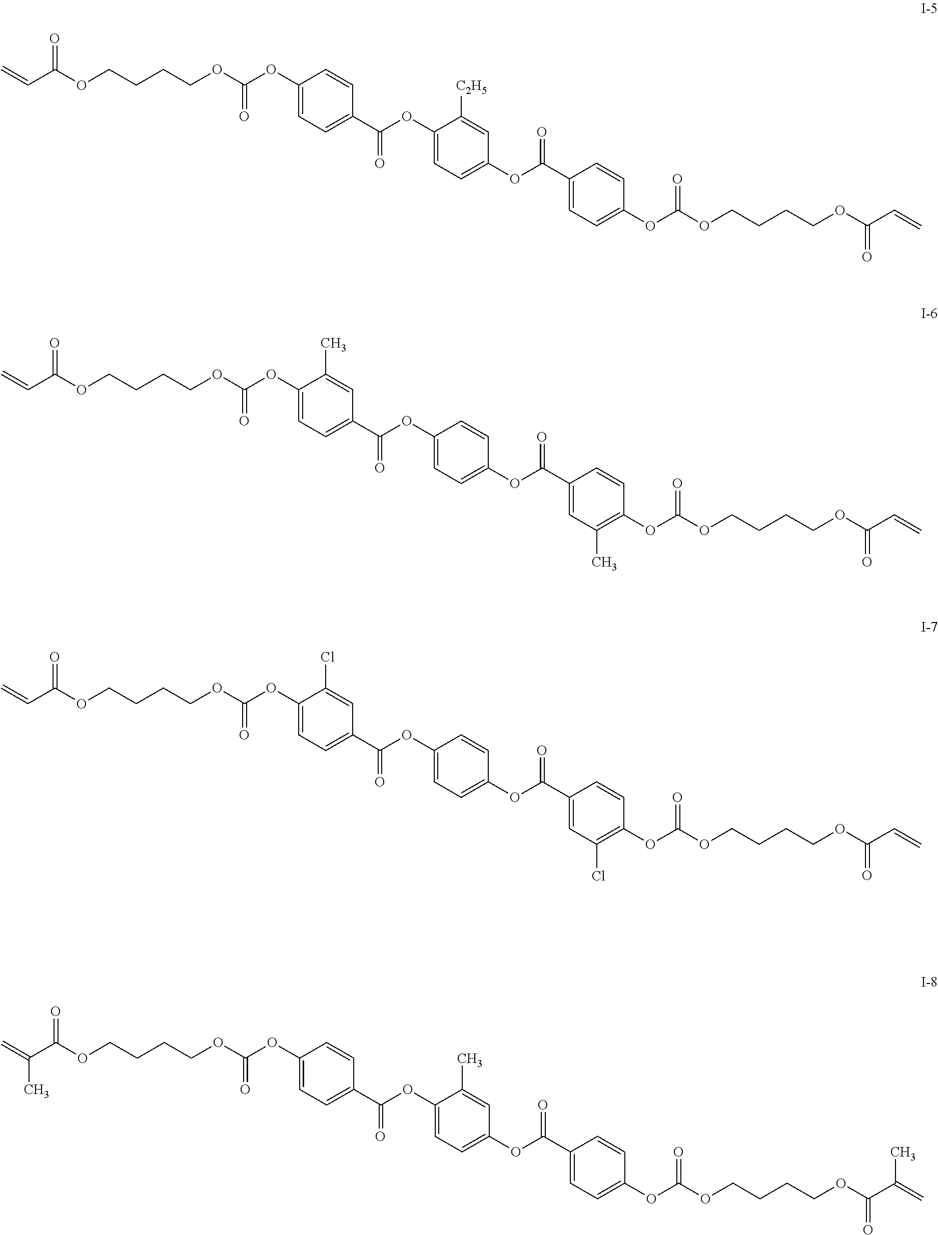

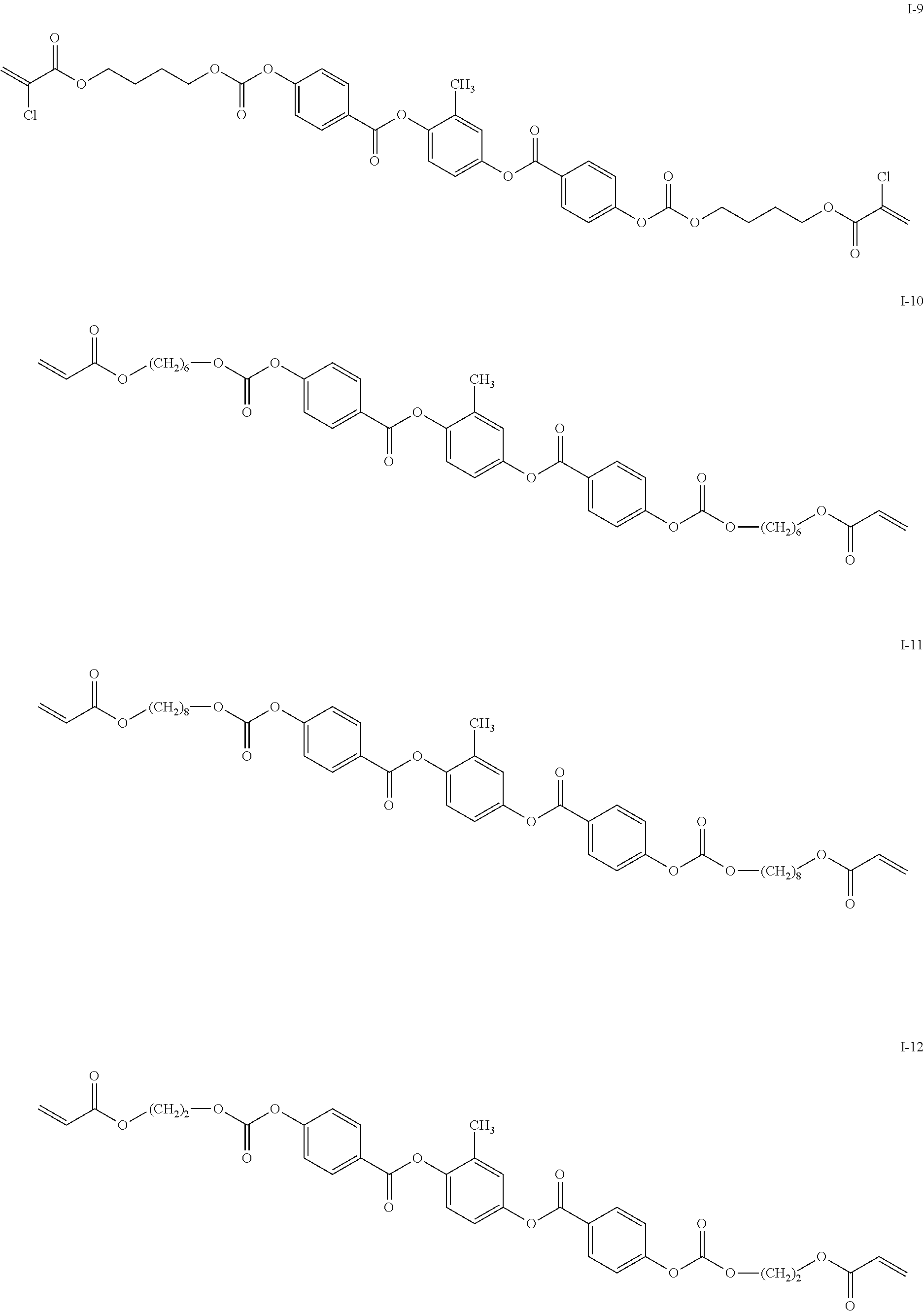

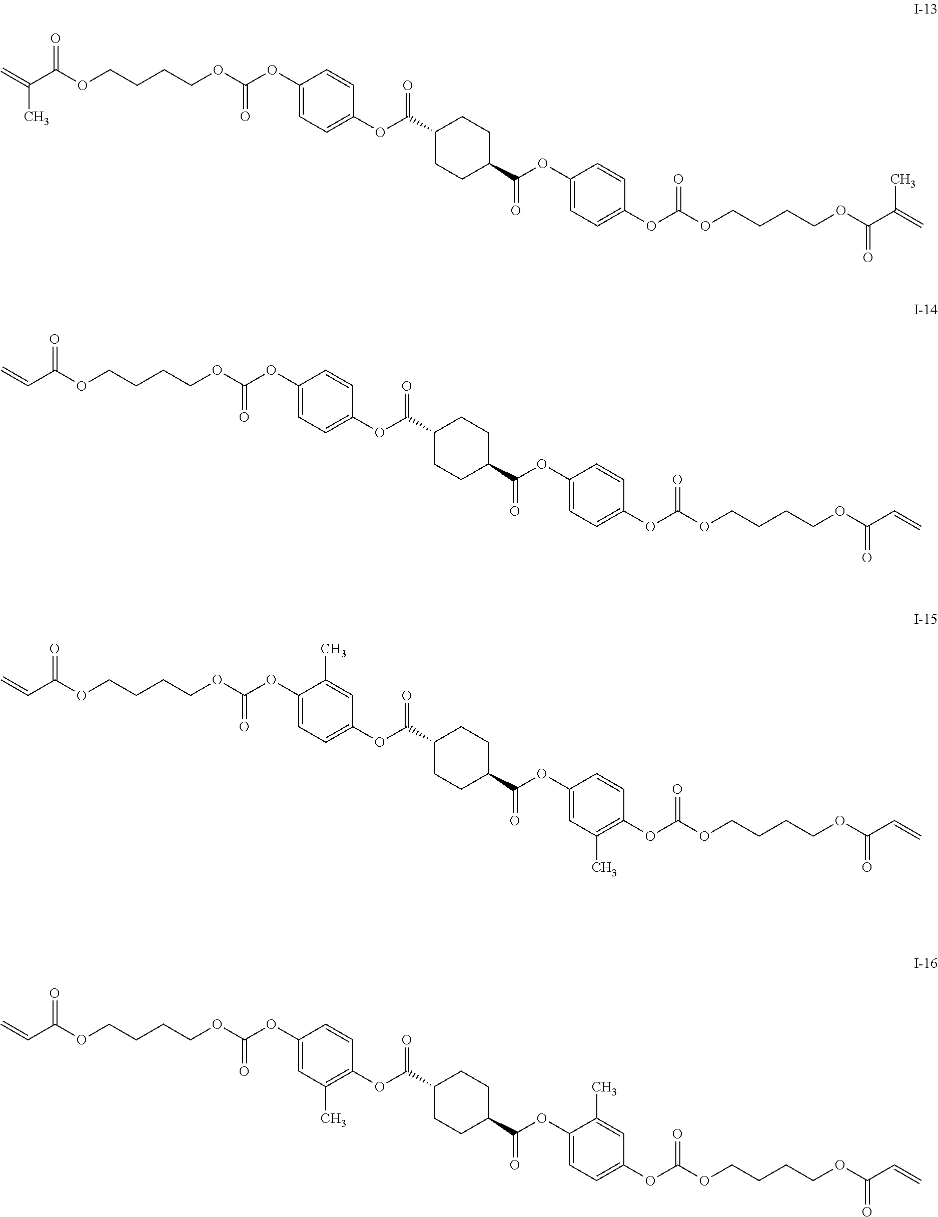

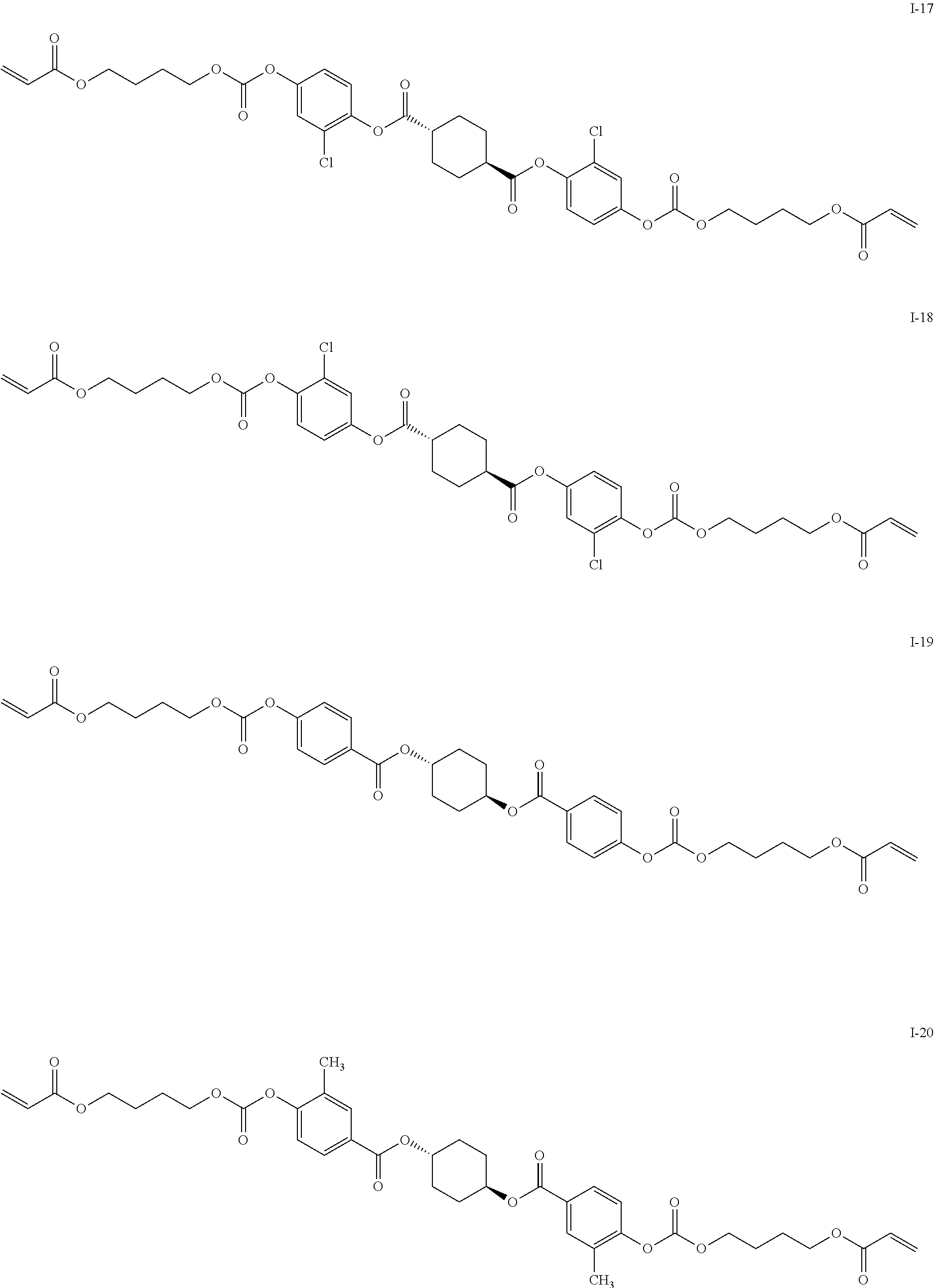

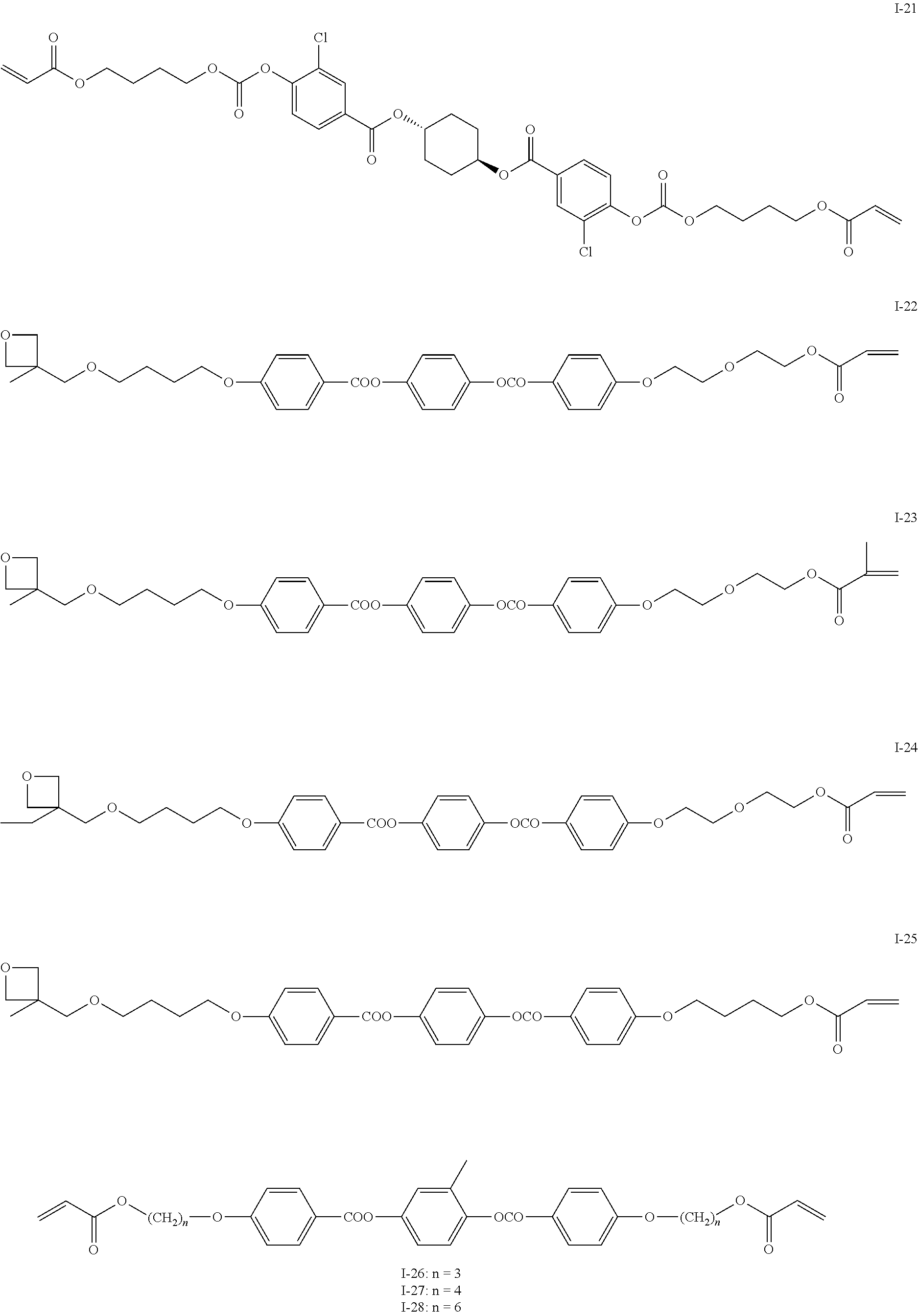

The polymerizable liquid-crystal compound may have two or more reactive groups, between which the polymerization condition differs. In this case, only a part of the different types of reactive groups may be polymerized by selecting the condition to thereby form a retardation layer that contains a polymer having unreacted reactive groups. Regarding the polymerization condition to be employed, the wavelength region of the ionizing radiation to be used for polymerization and fixation may be varied, or the polymerization mechanisms to be employed may be varied, but preferred is a combination of a radical reactive group and a cationic reactive group capable of being controlled by the type of the initiator to be used. More preferred is a combination where the radical reactive group is an acrylic group and/or a methacrylic group and the cationic group is a vinyl ether group, an oxetane group and/or an epoxy group, from the viewpoint of more easily controlling the reaction.

In general, a rod-shaped liquid crystal has a smaller retardation at a longer wavelength. Therefore, in case where a rod-shaped liquid crystal having a retardation at a wavelength G (550 nm) of λ/4, or that is, 137.5 nm is used, the retardation thereof is smaller than the above at a wavelength R (600 nm) but is larger at a wavelength B (450 nm). To solve this problem, preferably used is a rod-shaped liquid crystal having reversed wavelength dispersion characteristics of retardation (that the retardation is larger at a longer wavelength) for the wavelength in a visible region, or that is, satisfying Δnd(450 nm)<Δnd(550 nm)<Δnd(650 nm). Examples of the rod-shaped liquid crystal of the type include the compounds of the general formula (I) and the general formula (II) in JP-A 2007-279688.

One example of forming the optically-anisotropic layer includes applying a composition containing a polymerizable rod-shaped liquid crystal (for example, a coating liquid) onto the surface of the optical alignment layer or the rubbed alignment layer to be mentioned below, processing it to be in an alignment state having a desired liquid-crystal phase, and fixing the alignment state by heat or through exposure to ionizing radiation.

The composition for use in forming the optically-anisotropic layer is preferably prepared as a coating liquid. The solvent to be used in preparing the coating liquid is preferably an organic solvent. Examples of the organic solvent include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone), ethers (e.g., tetrahydrofuran, 1,2-dimethoxyethane). Preferred are alkyl halides and ketones. Two or more different types of organic solvents may be used here as combined.

Along with the polymerizable liquid-crystal compound, a polymerization initiator, a sensitizer, an aligning agent and the like such as those to be mentioned below may be added to the composition. In addition, the composition may contain a non-liquid-crystalline polymerizable monomer. The polymerizable monomer is preferably a compound having a vinyl group, a vinyloxy group, an acryloyl group or a methacryloyl group. When a polyfunctional monomer having two or more polymerizable reactive functional groups, for example, ethylene oxide-modified trimethylolpropane triacrylate is used, it is preferred as improving the durability of the layer. The non-liquid-crystalline polymerizable monomer is a non-liquid-crystalline ingredient, and therefore the amount thereof to be added is not more than 40% by mass of the liquid-crystal compound and is preferably from 0 to 20% by mass or so.

The polymerizable rod-shaped liquid crystal applied to the surface of the alignment layer or the like is processed to be in a desired alignment state. In the invention, preferably, the rod-shaped liquid crystal is aligned horizontally. The tilt angle is preferably from 0 to 5 degrees, more preferably from 0 to 3 degrees, even more preferably from 0 to 2 degrees, most preferably from 0 to 1 degree. An additive capable of promoting the horizontal alignment of the liquid crystal may be added to the optically-anisotropic layer, and examples of the additive include the compounds described in JP-A 2009-223001, [0055] to [0063].

The composition (for example coating liquid) containing the rod-like liquid crystal having the polymerizable group(s) is aligned in any alignment state, and then, the alignment state is preferably fixed via the polymerization thereof (the 5) step in the above-described process). The fixation is preferably carried out by polymerization reaction between the polymerizable groups introduced into the liquid crystalline compound. Examples of the polymerization reaction include thermal polymerization reaction using a thermal polymerization initiator, and photo-polymerization reaction using a photo-polymerization initiator, wherein photo-polymerization reaction is more preferable. Examples of the photo-polymerization initiator include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication No. S60-105667 and U.S. Pat. No. 4,239,850), and oxadiazole compounds (those described in U.S. Pat. No. 4,212,970). Examples of the cationic photo-polymerization initiator include organic sulfonium salts, iodonium salts and phosphonium salts, organic solfonium salts are preferable, and triphenyl sulfonium salts are especially preferable. Preferable examples of the counter ion thereof include hexafluoro antimonate and hexafluoro phosphate.

An amount of the photo-polymerization initiator to be used is preferably from 0.01 to 20% by mass, or more preferable from 0.5 to 5% by mass, with respect to the solid content of the coating liquid.

For enhancing the sensitivity, any sensitizer may be used along with the polymerization initiator. Examples of the sensitizer include n-butyl amine, triethyl amine, tri-n-butyl phosphine and thioxanthone. The photo-polymerization initiator may be used in combination with other photo-polymerization initiator(s). An amount of the photo-polymerization initiator is preferably from 0.01 to 20% by mass, or more preferably from 0.5 to 5% by mass, with respect to the solid content of the coating liquid. For carrying out the polymerization of the liquid crystal compound, an irradiation with UV light is preferably performed.

The patterned optically-anisotropic layer may be formed in various methods, and the production method is not specifically defined here.

One example is an embodiment of using a patterned alignment layer. In this embodiment, a patterned alignment layer having different alignment controlling capabilities is formed, and a liquid-crystal composition is disposed thereon so that the liquid crystal is aligned by the film. The liquid crystal is controlled for the alignment thereof owing to the different alignment controlling capabilities of the patterned alignment layer, therefore attaining different alignment states. By fixing the alignment states, a pattern of first and second retardation domains is formed according to the pattern of the patterned alignment layer. The patterned alignment layer may be formed according to a printing method, a mask rubbing method of rubbing an alignment layer, or a method of using mask exposure for an optical alignment layer.

A horizontal alignment layer (alignment layer for controlling the alignment of the major axis of liquid-crystal molecules in the alignment treatment direction (for example, in the rubbing direction)) and a vertical alignment layer (alignment layer for controlling the alignment of the major axis of liquid-crystal molecules in the direction vertical to the alignment treatment direction (for example, in the rubbing direction)) are patterned, and the polymerizable rod-shaped liquid crystal may be aligned thereon to form, for example, a ¼ wavelength, patterned optically-anisotropic layer comprising domains of which the slow axes are vertical to each other. The patterned alignment layer comprising such a horizontal alignment layer and a vertical alignment layer can be produced, for example, by forming the one film in a uniform coating mode, then forming the other film on the surface of the former in a patterned state according to a printing method or the like, and thereafter rubbing it uniformly in one direction. For this, for example, usable is a printing method of using a rubbery flexographic plate.

The optical alignment material for use for the optical alignment layer usable in the invention is described in many publications. For the alignment layer for use in the invention, for example, preferred examples include azo compounds as in JP-A 2006-285197, 2007-76839, 2007-138138, 2007-94071, 2007-121721, 2007-140465, 2007-156439, 2007-133184, 2009-109831, Japanese Patents 3883848, 4151746; aromatic ester compounds as in JP-A 2002-229039; maleimide and/or alkenyl-substituted nadimide compounds having an optical alignment unit, as in JP-A 2002-265541, 2002-317013; photocrosslinked silane derivatives as in Japanese Patents 4205195, 4205198; photocrosslinked polyimides, polyamides and esters as in JP-T 2003-520878, 2004-529220, Japanese Patent 4162850. Especially preferred are azo compounds, photocrosslinked polyimides, polyamides and esters.

Another example is a method of using pattern exposure. In this example, formed is a patterned optically-anisotropic layer that comprises a domain having Re of 0 and a domain having Re in a given range. Concretely, a rod-shaped liquid crystal is made to be in a predetermined alignment state, and then pattern-exposed to fix the alignment state, thereby forming one retardation domain (retardation domain having Re in a given range). Next, this is heated at a temperature not lower than the isotropic phase temperature thereof so as to make the unexposed part have an isotropic phase, and then photoexposed to fix the isotropic phase thereby forming the other domain having Re of 0. Using rod-shaped liquid crystals having different polymerizable groups may form similarly a patterned optically-anisotropic layer.

Not specifically defined, the thickness of the thus-formed, optically-anisotropic layer is preferably from 0.1 to 10 micro meters, more preferably from 0.5 to 5 micro meters.

### Transparent Support:

The optically-anisotropic layer may be supported by a transparent polymer film or the like. In case where the polymer film is disposed between the optically-anisotropic layer and the polarizing film, the film may serve also as a protective film for the polarizing film. In case where the polymer film is disposed on the opposite surface of the optically-anisotropic layer to the surface thereof on which the polarizing film is disposed, the polymer film may also serve as a support for any other functional layer, for example, an antireflection layer or the like. As the support, preferred is use of a polymer film having low Re and low Rth. In an embodiment where the optically-anisotropic layer is formed of a rod-shaped liquid-crystal composition, Rth of the optically-anisotropic layer is positive, and therefore also preferred is use of a polymer film of which Rth is negative to counterbalance the positive Rth of the optically-anisotropic layer.

The material for forming the polymer film for use as the support includes, for example, polycarbonate polymers; polyester polymers such as polyethylene terephthalate, polyethylene naphthalate, etc.; acrylic polymers such as polymethyl methacrylate, etc.; styrenic polymers such as polystyrene, acrylonitrile/styrene copolymer (AS resin), etc. As other examples of the material usable herein, also mentioned are polyolefins such as polyethylene, polypropylene, etc.; polyolefinic polymers such as ethylene/propylene copolymer, etc.; vinyl chloride polymers; amide polymers such as nylon, aromatic polyamides, etc.; imide polymers; sulfone polymers; polyether sulfone polymers; polyether ether ketone polymers; polyphenylene sulfide polymers; vinylidene chloride polymers; vinyl alcohol polymers; vinylbutyral polymers; arylate polymers, polyoxymethylene polymers; epoxy polymers; mixed polymers prepared by mixing the above-mentioned polymers. The polymer film in the invention may be formed as a cured layer of a UV-curable or thermocurable resin such as acrylic, urethane, acrylurethane, epoxy, silicone or the like resins.

As the material for forming the transparent support, also preferred is use of thermoplastic norbornene resins. As the thermoplastic norbornene resins, there are mentioned Nippon Zeon's Zeonex and Zeonoa; JSR's Arton, etc.

As the material for forming the transparent support, also preferred is use cellulose polymer (hereinafter this may be referred to as cellulose acylate) such as typically triacetylcellulose, which has heretofore been used as a transparent protective film for polarizing plate.

### Polarizing Film:

As the polarizing film, any ordinary polarizing film is usable here. For example, a polarizing film of a polyvinyl alcohol or the like dyed with iodine or a dichroic dye can be used here.

### Adhesive Layer:

An adhesive layer may be disposed between the optically-anisotropic layer and the polarizing film. The adhesive layer to be used for laminating the optically-anisotropic layer and the polarizing film is, for example, a substance having a ratio of G′/G″ (tan δ=G″/G′), as measured with a dynamic viscoelastometer, of from 0.001 to 1.5, and includes so-called adhesives, easily creeping substances, etc. The adhesives are not specifically defined, and for example, polyvinyl alcohol adhesives are usable here.

### Antireflection Layer:

Preferably, a functional film such as an antireflection layer or the like is disposed on the opposite surface of the optically-anisotropic layer to the surface thereof on which the liquid-crystal cell is disposed. In particular, in the invention, preferred is use of an antireflection layer comprising at least a light-scattering layer and a low refractivity layer as laminated in that order on a substrate film (surface film support) or an antireflection layer comprising a middle refractivity layer, a high refractivity layer and a low refractivity layer as laminated in that order on a substrate film. This is because the antireflection layer of the type can effectively prevent flickering that may occur owing to external light reflection in 3D image displaying. The antireflection layer may further have a hard coat layer, a front scattering layer, a primer layer, an antistatic layer, an undercoat layer, a protective layer, etc. The details of the layers constituting the antireflection layer are described in JP-A 2007-254699, [0182] to [0220], and the same shall apply to the preferred characteristics and the preferred materials of the antireflection layer usable in the invention.

The substrate film may serve also as a transparent support for the optically-anisotropic layer. Examples of the polymer film usable as the substrate film are the same as the examples of the transparent support of the optically-anisotropic layer mentioned above, and the preferred range thereof is also the same as that of the latter.

Re(550) of the substrate film is preferably from −5 to 10 nm, more preferably from −2 to 7 nm, even more preferably from 0 to 5 nm. Rth(550) of the substrate film is preferably from −200 to 0 nm, more preferably from −170 to 0 nm, even more preferably from −150 to 0 nm.

### Liquid-Crystal Cell:

The liquid-crystal cell for use in the 3D image display device to be used in the 3D image display system of the invention is preferably a VA-mode, OCB-mode, IPS-mode or TN-mode cell, to which, however, the invention is not limited.

In the TN-mode liquid-crystal cell, rod-shaped liquid-crystal molecules are aligned substantially horizontally and are further twisted at from 60 to 120° under the condition of no voltage application thereto. The TN-mode liquid-crystal cell is most used in color TFT liquid-crystal display devices, and is described in many publications.

In the VA-mode liquid-crystal cell, rod-shaped liquid-crystal molecules are aligned substantially vertically under the condition of no voltage application thereto. The VA-mode liquid-crystal cell includes (1) a narrowly-defined VA-mode liquid-crystal cell where rod-shaped liquid-crystal molecules are aligned substantially vertically under the condition of no voltage application thereto but are aligned substantially horizontally under the condition of voltage application thereto (as described in JP-A 2-176625), and in addition thereto, further includes (2) an MVA-mode liquid-crystal cell in which the VA-mode has been multidomained (as described in SID97, Digest of Tech. Papers (preprints) 28 (1997) 845), (3) an n-ASM mode liquid-crystal cell in which rod-shaped liquid-crystal molecules are aligned substantially vertically under the condition of no voltage application thereto and are aligned in a twisted multidomain alignment under the condition of voltage application thereto (as described in preprints of Discussion in Japanese Liquid Crystal Society, 58-59 (1998)), and (4) a SURVIVAL-mode liquid-crystal cell (as announced in LCD International 98). In addition, the liquid-crystal cell may be in any mode of a PVA (patterned vertical alignment)-mode cell, an OP (optical alignment)-mode cell or a PSA (polymer-sustained alignment)-mode cell. The details of these modes are described in JP-A 2006-215326 and JP-T 2008-538819.

In the IPS-mode liquid-crystal cell, rod-shaped liquid-crystal molecules are aligned substantially horizontally to the substrate, and when an electric field parallel to the substrate face is given thereto, the liquid-crystal molecules respond planarly thereto. In the IPS-mode liquid-crystal cell, the panel is in a black display state under the condition of no electric field application thereto, and the absorption axes of the pair of upper and lower polarizing plates are perpendicular to each other. A method of using an optical compensatory sheet to reduce the light leakage in oblique directions at the time of black level of display to thereby expand the viewing angle is disclosed in JP-A 10-54982, 11-202323, 9-292522, 11-133408, 11-305217, 10-307291, etc.

### Polarizing Plate for 3D Image Display System:

In the 3D image display system of the invention, stereoscopic images of so-called 3D visions are recognized by viewers through a polarizing plate. One embodiment of the polarizing plate is polarized glasses. In the above-mentioned embodiment where right-eye and left-eye circularly-polarized images are formed via a retardation plate, used are circularly-polarized glasses; and in the embodiment where linearly-polarized images are formed, used are linearly-polarized glasses. Of these embodiments, the system is preferably so designed that the right-eye image light outputted from any of the first and second retardation domains of the optically-anisotropic layer runs into the right-eye glass but is blocked by the left-eye glass while the left-eye image light outputted from the other of the first and second retardation domains runs through the left-eye glass but is blocked by the right-eye glass.

The polarized glasses each contain a retardation function layer and a linear polarizing element. In these, any other member having the same function as that of the linear polarizing element may also be used.

The concrete configurations of the 3D image display system of the invention, including polarized glasses, are described below. First, the retardation plate is so designed as to have the above-mentioned first retardation domain and the above-mentioned second retardation domain that differ in the polarized light conversion function on multiple first lines and multiple second lines alternately repeated in the image display panel (for example, when the lines run in the horizontal direction, the domains may be on the odd-numbered lines and even-numbered lines in the horizontal direction, and when the lines run in the vertical direction, the domains may be on the odd-numbered lines and the even-numbered lines in the vertical direction). In case where a circularly-polarized light is used for display, the retardation of the above-mentioned first retardation domain and that of the second retardation domain are preferably both λ/4, and more preferably, the slow axes of the first retardation domain and the second retardation domain are perpendicular to each other.

In case where a circularly-polarized light is used for display, preferably, the retardation of the above-mentioned first retardation domain and that of the second retardation domain are both λ/4, the right-eye image is displayed on the odd-numbered lines of the image display panel, and when the slow axis in the odd-lined retardation domain is in the direction of 45 degrees, a λ/4 plate is disposed in both the right-eye glass and the left-eye glass of the polarized glasses, and the λ/4 plate of the right-eye glass of the polarized glasses may be fixed concretely at about 45 degrees. In the above-mentioned situation, similarly, the left-eye image is displayed on the even-numbered lines of the image display panel, and when the slow axis of the even-numbered line retardation domain is in the direction of 135 degrees, then the slow axis of the left-eye glass of the polarized glasses may be fixed concretely at about 135 degrees.

Further, from the viewpoint that a circularly-polarized image light is once outputted via the patterned retardation film and its polarization state is returned to the original state through the polarized eyeglasses, the angle of the slow axis to be fixed of the right-eye glass in the above-mentioned case is preferably nearer to accurately 45 degrees in the horizontal direction. Also preferably, the angle of the slow axis to be fixed of the left-eye glass is nearer to accurately 135 degrees (or 45 degrees) in the horizontal direction.

For example, in a case where the image display panel is a liquid-crystal display panel, in general, it is desirable that the absorption axis direction of the panel front-side polarizing plate is in the horizontal direction and the absorption axis of the linear polarizing element of the polarized glasses is in the direction perpendicular to the absorption axis direction of the front-side polarizing plate, and more preferably, the absorption axis of the linear polarizing element of the polarized glasses is in the vertical direction.

Also preferably, the absorption axis direction of the liquid-crystal display panel front-side polarizing plate is at an angle of 45 degrees to each slow axis of the odd-numbered line retardation domain and the even-numbered line retardation domain of the patterned retardation film from the viewpoint of the polarized light conversion efficiency of the system.

Preferred configurations of the polarized glasses as well as those of the patterned retardation film and the liquid-crystal display device are disclosed in, for example, JP-A 2004-170693.

As examples of polarized glasses usable here, there are mentioned those described in JP-A 2004-170693, and as commercial products thereof, there are mentioned accessories to Zalman's ZM-M220 W.

### EXAMPLES

The invention is described in more detail with reference to the following Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

### Example 1

### Production of Transparent Support A

The following ingredients were put into a mixing tank and dissolved by stirring under heat, thereby preparing a cellulose acylate solution A.

Formulation of Cellulose Acylate Solution A

| | |
|---|---|
| Cellulose acylate having a degree of | 100 parts by mass |
| substitution of 2.86 | |
| Triphenyl phosphate (plasticizer) | 7.8 parts by mass |
| Biphenyldiphenyl phosphate (plasticizer) | 3.9 parts by mass |
| Methylene chloride (first solvent) | 300 parts by mass |
| Methanol (second solvent) | 54 parts by mass |
| 1-Butanol | 11 parts by mass |

The following ingredients were put into a different mixing tank and dissolved by stirring under heat, thereby preparing an additive solution B.

Formulation of Additive Solution B

| | |
|---|---|
| Compound B1 mentioned below (Re reducer) | 40 parts by mass |
| Compound B2 mentioned below (wavelength dispersion | 4 parts by mass |
| characteristics-controlling agent) | |
| Methylene chloride (first solvent) | 80 parts by mass |
| Methanol (second solvent) | 20 parts by mass |

Compound B1: 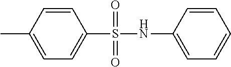 [SMILES: Cc1ccc(S(=O)(=O)Nc2ccccc2)cc1]
Compound B2:

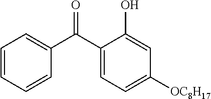

### <<Production of Cellulose Acetate Transparent Support>>

40 parts by mass of the additive solution B was added to 477 parts by mass of the cellulose acylate solution A, and fully stirred to prepare a dope. The dope was cast onto a drum cooled at 0 degree Celsius, via a casting mouth. When the solvent content therein reached 70% by mass, the formed film was peeled, and both sides in the width direction thereof were fixed with a pin tenter (described in FIG. 3 in JP-A 4-1009). When the solvent content in the film was from 3 to 5% by mass and while the distance of the pin tenter was controlled so that the draw ratio of the film was 3% in the transverse direction (in the direction transverse to the machine direction), the film was dried. Subsequently, the film was conveyed between rolls of a heat treatment apparatus and was thus further dried, thereby giving a cellulose acetate protective film (transparent support A) having a thickness of 60 micro meters. The transparent support A does not contain a UV absorbent, and Re(550) thereof was 0 nm and Rth(550) thereof was 12.3 nm.

### <<Alkali Saponification Treatment>>

The cellulose acetate transparent support A was made to pass through dielectric heating rolls at a temperature of 60 degrees Celsius to thereby elevate the film surface temperature up to 40 degrees Celsius, and then using a bar coater, an alkali solution having the composition mentioned below was applied onto one surface of the film in a coating amount of 14 ml/m². Then, this was heated at 110 degrees Celsius and conveyed below a steam-type far IR heater made by Noritake Company Ltd., for 10 seconds. Subsequently, also using a bar coater, pure water was applied to the film in an amount of 3 ml/m². Next, this was washed with water using a fountain coater, and then dewatered using an air knife, and this operation was repeated three times. Subsequently, the film was conveyed in a drying zone at 70 degrees Celsius for 10 seconds, and dried therein thereby giving an alkali-saponified cellulose acetate transparent support A.

Formulation of Alkali Solution (part by mass)

| | |
|---|---|
| Potassium hydroxide | 4.7 parts by mass |
| Water | 15.8 parts by mass |
| Isopropanol | 63.7 parts by mass |
| Surfactant SF-1: C₁₄H₂₉O(CH₂CH₂O)₂₀H | 1.0 part by mass |
| Propylene glycol | 14.8 parts by mass |

<Production of Support A with Photo-Alignment Layer>

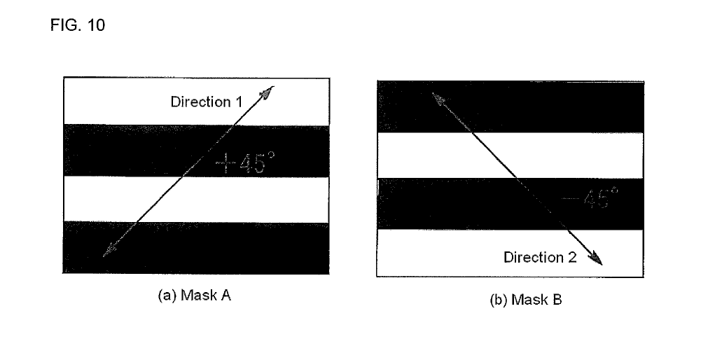

An aqueous 1% solution of an optically-aligning material E-1 having the structure mentioned below was applied onto the saponified surface of the transparent substrate A produced in Example 1, and dried at 100 degrees Celsius for 1 minute. The formed coating film was irradiated with UV rays in air, using an air-cooled metal halide lamp (by Eye Graphics) having a lighting intensity of 160 W/cm². In this step, a wire grid polarizing element (Moxtek's ProFlux PPL02) was set in the direction 1 as in FIG. 10(a), and the layer was photoexposed via the mask A (stripe mask having a lateral stripe width in the transmitting part of 285 micro meters and a lateral stripe width in the blocking part of 285 micro meters). Subsequently, the wire grid polarizing element was set in the direction 2 as in FIG. 10(b), and the layer was photoexposed via the mask B (stripe mask having a lateral stripe width in the transmitting part of 285 micro meters and a lateral stripe width in the blocking part of 285 micro meters). The distance between the photoexposure mask and the photo-alignment layer was 200 micro meters. The lighting intensity of UV rays used in the case was 100 mW/cm² in the UV-A region (integration at a wavelength of from 380 nm to 320 nm), and the irradiation dose was 1000 mJ/cm² in the UV-A region.

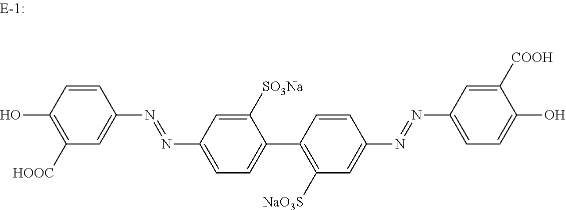

### <Formation of Patterned Optically-Anisotropic Layer A>

The composition for optically-anisotropic layer mentioned below was prepared, and filtered through a polypropylene filter having a pore size of 0.2 micro meters to prepare a coating liquid for use herein. The coating liquid was applied onto the transparent support A with a photo-alignment layer, and dried at a film surface temperature of 105 degrees Celsius for 2 minutes to form a liquid-crystal phase state, and thereafter cooled to 75 degrees Celsius. In air, this was exposed to UV rays, using an air-cooled metal halide lamp (by Eye Graphics) having a lighting intensity of 160 W/cm², to thereby fix the alignment state to form a patterned optically-anisotropic layer A on the transparent support A. The thickness of the optically-anisotropic layer was 1.3 micro meters.

Formulation of Optically-Anisotropic Layer

| | |
|---|---|
| Rod-shaped liquid crystal (LC242, by BASF) | 100 parts by mass |
| Horizontally aligning agent A | 0.3 parts by mass |
| Photopolymerization initiator (Irgacure 907, by | 3.3 parts by mass |
| Ciba Specialty Chemicals) | |
| Sensitizer (Kayacure DETX, by Nippon Kayaku) | 1.1 parts by mass |
| Methyl ethyl ketone | 300 parts by mass |

### Rod-Shaped Liquid Crystal LC242: Rod-Shaped Liquid Crystal Described in WO2010/090429A2:

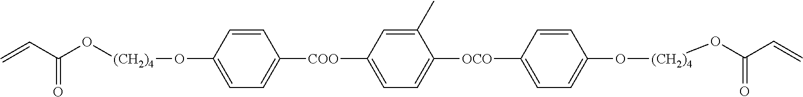

### Horizontally-Aligning Agent A:

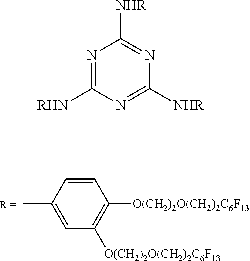

### (Evaluation of Optically-Anisotropic Layer)

The formed optically-anisotropic layer was peeled from the transparent support A, and then put between two polarizing plates that had been combined orthogonally in a manner so that the slow axis of any one of the first retardation domain or the second retardation domain of the layer was parallel to the polarization axis of any one of the polarizing plates, and further, a sensitive color plate having a retardation of 530 nm was put on the optically-anisotropic layer in a manner so that the slow axis of the plate was at an angle of 45° relative to the polarization axis of the polarizing plates. Next, the optically-anisotropic layer was rotated by +45°, and the condition was observed with a polarizing microscope (Nikon's ECLIPE E600 W POL). As obvious from the observed result shown in FIG. 9, when the layer was rotated by +45°, the slow axis of the first retardation domain became parallel to the slow axis of the sensitive color plate, and therefore the retardation was larger than 530 nm and the color changed to blue (the dark part in the black and white illustration). On the other hand, since the slow axis of the second retardation domain was perpendicular to the slow axis of the sensitive color plate, the retardation became smaller than 530 nm and the color changed to white (the pale part in the black and white illustration). Table 2 shows the relationship between the slow axis of the optically-anisotropic layer and the photoexposure direction of the alignment layer. The results in Table 2 confirm the following: When a rod-shaped liquid crystal is aligned and photoexposed on an photo-alignment layer, then a patterned optically-anisotropic layer having a first retardation domain and a second retardation domain is formed in which the liquid crystal is horizontally aligned and the slow axes of the two domains are perpendicular to each other.

Next, using KOBRA-21ADH (by Oji Scientific Instruments) and according to the above-mentioned method, the tilt angle of the rod-shaped liquid crystal in the alignment layer interface, the tilt angle of the rod-shaped liquid crystal in the air-side interface, the direction of the slow axis, Re and Rth of the layer were measured. The results are shown in Table 2. In the following Table, “horizontal” means a tilt angle of from 0° to 20°.

From the results in Table 2, it is understood that, when a rod-shaped liquid crystal is aligned on an photo-alignment layer that has been mask-exposed through polarization, in the presence of a horizontally-aligning agent, then there is formed a patterned optically-anisotropic layer having a first retardation domain and a second retardation domain in which the liquid crystal is horizontally aligned and the slow axes of the two domains are perpendicular to each other.

### <Production of Surface Film A>

### <<Formation of Antireflection Layer>>

### [Preparation of Coating Liquid for Hard Coat Layer]

The following ingredients were put into a mixing tank and stirred to prepare a hard coat layer coating liquid.

100 parts by mass of cyclohexanone, 750 parts by mass of a partially caprolactone-modified polyfunctional acrylate (DPCA-20, by Nippon Kayaku), 200 parts by mass of silica sol (MIBK-ST, by Nissan Chemical), and 50 parts by mass of a photopolymerization initiator (Irgacure 184, by Ciba Specialty Chemicals) were added to 900 parts by mass of methyl ethyl ketone, and stirred. The mixture was filtered through a polypropylene filter having a pore size of 0.4 micro meters to prepare a coating liquid for hard coat layer.

### [Preparation of Coating Liquid A for Middle Refractivity Layer]

1.5 parts by mass of a mixture of dipentaerythritol pentaacrylate and dipentaerythritol hexaacrylate (DPHA), 0.05 parts by mass of a photopolymerization initiator (Irgacure 907, by Ciba Specialty Chemicals), 66.6 parts by mass of methyl ethyl ketone, 7.7 parts by mass of methyl isobutyl ketone and 19.1 parts by mass of cyclohexanone were added to 5.1 parts by mass of a ZrO₂ fine particles-containing hard coat agent (Desolight Z7404 [having a refractive index of 1.72, a solid concentration of 60% by mass, a content of zirconium oxide fine particles of 70% by mass (relative to solid fraction), a mean particle diameter of zirconium oxide fine particles of about 20 nm, a solvent composition of methyl isobutyl ketone/methyl ethyl ketone of 9/1, by JSR], and stirred. After fully stirred, the mixture was filtered through a polypropylene filter having a pore size of 0.4 micro meters to prepare a coating liquid A for middle refractivity layer.

### [Preparation of Coating Liquid B for Middle Refractivity Layer]

4.5 parts by mass of a mixture of dipentaerythritol pentaacrylate and dipentaerythritol hexaacrylate (DPHA), 0.14 parts by mass of a photopolymerization initiator (Irgacure 907, by Ciba Specialty Chemicals), 66.5 parts by mass of methyl ethyl ketone, 9.5 parts by mass of methyl isobutyl ketone and 19.0 parts by mass of cyclohexanone were stirred. After fully stirred, the mixture was filtered through a polypropylene filter having a pore size of 0.4 micro meters to prepare a coating liquid B for middle refractivity layer.

The coating liquid A for middle refractivity layer and the coating liquid B for middle refractivity layer were suitably mixed to give a coating liquid for middle refractivity layer capable of having a refractive index of 1.36 and capable of forming a layer having a thickness of 90 micro meters.

### [Preparation of Coating Liquid for High Refractivity Layer]

0.75 parts by mass of a mixture of dipentaerythritol pentaacrylate and dipentaerythritol hexaacrylate (DPHA), 62.0 parts by mass of methyl ethyl ketone, 3.4 parts by mass of methyl isobutyl ketone and 1.1 parts by mass of cyclohexanone were added to 14.4 parts by mass of a ZrO₂ fine particles-containing hard coat agent (Desolight Z7404 [having a refractive index of 1.72, a solid concentration of 60% by mass, a content of zirconium oxide fine particles of 70% by mass (relative to solid fraction), a mean particle diameter of zirconium oxide fine particles of about 20 nm, a solvent composition of methyl isobutyl ketone/methyl ethyl ketone of 9/1, and containing a photopolymerization initiator, by JSR], and stirred. After fully stirred, the mixture was filtered through a polypropylene filter having a pore size of 0.4 micro meters to prepare a coating liquid C for high refractivity layer.

### [Preparation of Coating Liquid for Low Refractivity Layer]

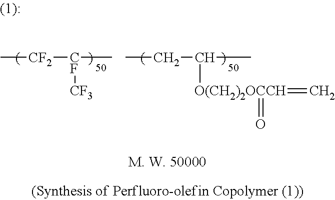

In the above structural formula, 50/50 is a ratio by mol.

40 ml of ethyl acetate, 14.7 g of hydroxyethyl vinyl ether and 0.55 g of dilauroyl peroxide were put into an autoclave having an inner capacity of 100 ml and equipped with a stainless stirrer, and the system was degassed and purged with nitrogen gas. Further, 25 g of hexafluoropropylene (HFP) was introduced into the autoclave and heated up to 65 degrees Celsius. The pressure when the temperature inside the autoclave reached 65 degrees Celsius was 0.53 MPa (5.4 kg/cm²). While kept at the temperature, the reaction was continued for 8 hours, and when the pressure reached 0.31 MPa (3.2 kg/cm²), the heating was stopped and the system was left cooled. After the inner temperature lowered to room temperature, the unreacted monomer was expelled away, and the autoclave was opened to take out the reaction liquid. The obtained reaction liquid was put into a large excessive amount of hexane, and the solvent was removed through decantation to thereby take out the precipitated polymer. Further, the polymer was dissolved in a small amount of ethyl acetate and reprecipitated twice from hexane to thereby completely remove the remaining monomer. After dried, 28 g of a polymer was obtained. Next, 20 g of the polymer was dissolved in 100 ml of N,N-dimethylacetamide, and with cooling with ice, 11.4 g of acrylic acid chloride was dropwise added thereto, and then stirred at room temperature for 10 hours. Ethyl acetate was added to the reaction liquid, then this was washed with water, and the organic layer was extracted out and concentrated. The resulting polymer was reprecipitated from hexane to give 19 g of a perfluoro-olefin copolymer (1). The refractive index of the thus-obtained polymer was 1.422, and the mass-average molecular weight thereof was 50000.

### [Preparation of Hollow Silica Particles Dispersion A]

30 parts by mass of acryloyloxypropyltrimethoxysilane and 1.51 parts by mass of diisopropoxyaluminiumethyl acetate were added to and mixed with 500 parts by mass of a sol of hollow silica fine particles (isopropyl alcohol silica sol, Catalysts & Chemicals Industries' CS60-IPA, having a mean particle diameter of 60 nm, a shell thickness of 10 nm, a silica concentration of 20% by mass, a refractive index of silica particles of 1.31), and then 9 parts by mass of ion-exchanged water was added thereto. After reacted at 60 degrees Celsius for 8 hours, this was cooled to room temperature, then 1.8 parts by mass of acetylacetone was added thereto to prepare a dispersion. Subsequently, while cyclohexanone was added thereto until the silica content became almost constant, the system was processed for solvent substitution through reduced pressure distillation under a pressure of 30 Torr, thereby giving a dispersion A having a solid concentration of 18.2% by mass through final concentration control. The remaining IPA amount in the thus-obtained dispersion A was at most 0.5% by mass, as found through gas chromatography.

### [Preparation of Coating Liquid for Low Refractivity Layer]

The following ingredients were mixed and dissolved in methyl ethyl ketone to prepare a coating liquid Ln6 for low refractivity layer having a solid concentration of 5% by mass. The amount of each ingredient shown below is the ratio of the solid content of each ingredient, in terms of % by mass relative to the total amount of the coating liquid.

| | |
|---|---|
| P-1: perfluoro-olefin copolymer (1) | 15% by mass |
| DPHA: mixture of dipentaerythritol pentaacrylate and | 7% by mass |
| dipentaerythritol hexaacrylate (by Nippon Kayaku) | |
| MF1: fluorine-containing unsaturated compound | 5% by mass |
| mentioned below, described in Examples in WO2003/ | |
| 022906 (having a weight-average molecular | |
| weight of 1600) | |
| M-1: Nippon Kayaku's KAYARAD DPHA | 20% by mass |
| Dispersion A: hollow silica particles dispersion | 50% by mass |
| A mentioned above (sol of hollow silica particles surface- | |
| modified with acryloyloxypropyltrimethoxysilane, | |
| having a solid concentration of 18.2%) | |
| Irg 127: photopolymerization initiator Irgacure 127 | 3% by mass |
| (by Ciba Specialty Chemicals) | |

Fluorine-Containing Unsaturated Compound: 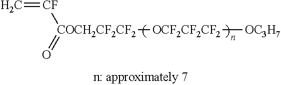
Air-Side Interface Aligning Agent (P-1):

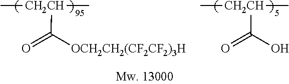

### <Production of Transparent Support B>

### <<Production of Cellulose Acetate Transparent Support B>>

A cellulose acylate solution (dope) having the composition mentioned below was prepared.

| | |
|---|---|
| Methylene chloride | 435 parts by mass |
| Methanol | 65 parts by mass |
| Cellulose acylate benzoate (CBZ) (having a degree | 100 parts by mass |
| of acetyl substitution of 2.45, a degree of benzoyl | |
| substitution of 0.55, an a mass-average | |
| molecular weight of 180000) | |
| Silicon dioxide fine particles (having a mean particle | 0.25 parts by mass |
| size of 20 nm and a Mohs hardness of about 7) | |

The obtained dope was cast on a film-forming band, dried at room temperature for 1 minute, and then dried at 45 degrees Celsius for 5 minutes. After dried, the residual solvent amount in the film was 30% by mass. The cellulose acylate film was peeled from the bad, dried at 100 degrees Celsius for 10 minutes and then at 130 degrees Celsius for 20 minutes, thereby giving a cellulose acetate film transparent support B (transparent support B). The residual solvent amount was 0.1% by mass. The transparent support B did not contain a UV absorbent, its thickness was 45 micro meters, its Re(550) was 0 nm, and its Rth(550) was −75 nm.

### <Production of Surface Film A>

The transparent support B was used as the support for surface film. Using a gravure coater, the above-mentioned hard coat layer coating liquid was applied onto the surface film support B. This was dried at 100 degrees Celsius. While purged with nitrogen so that the atmosphere had an oxygen concentration of not more than 1.0% by volume, the coating layer was cured through exposure to UV rays, using an air-cooled, 160 W/cm metal halide lamp (by Eye Graphics) at a lighting intensity of 400 mW/cm² and at a dose of 150 mJ/cm², thereby forming a hard coat layer A having a thickness of 12 micro meters.

Further, the middle refractivity layer coating liquid, the high refractivity layer coating liquid and the low refractivity layer coating liquid were applied to the above, using a gravure coater. The drying condition for the middle refractivity layer was at 90 degrees Celsius and for 30 seconds. The UV curing condition was as follows: While purged with nitrogen so that the atmosphere had an oxygen concentration of not more than 1.0% by volume, the coating layer was cured through exposure to UV rays, using an air-cooled, 180 W/cm metal halide lamp (by Eye Graphics) at a lighting intensity of 300 mW/cm² and at a dose of 240 mJ/cm².

The drying condition for the high refractivity layer was at 90 degrees Celsius and for 30 seconds. The UV curing condition was as follows: While purged with nitrogen so that the atmosphere had an oxygen concentration of not more than 1.0% by volume, the coating layer was cured through exposure to UV rays, using an air-cooled, 240 W/cm metal halide lamp (by Eye Graphics) at a lighting intensity of 300 mW/cm² and at a dose of 240 mJ/cm².

The drying condition for the low refractivity layer was at 90 degrees Celsius and for 30 seconds. The UV curing condition was as follows: While purged with nitrogen so that the atmosphere had an oxygen concentration of not more than 0.1% by volume, the coating layer was cured through exposure to UV rays, using an air-cooled, 240 W/cm metal halide lamp (by Eye Graphics) at a lighting intensity of 600 mW/cm² and at a dose of 600 mJ/cm². Accordingly, a surface film A was produced.

### <Production of Optical Film A>

The transparent support B side of the surface film A produced in the above and the optically-anisotropic layer side of the patterned optically-anisotropic layer A were stuck together using an adhesive to produce an optical film A.

### <Production of Polarizing Plate A>

TD80UL (by FUJIFILM, having Re/Rth=2/40 at 550 nm) was used as a protective film A for polarizing plate A. Its surface was alkali-saponified. Briefly, the film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath at room temperature, and then dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using a 3% aqueous solution of polyvinyl alcohol (Kuraray's PVA-117H) as an adhesive, the alkali-saponified film TD80UL mentioned above and a retardation film for VA mode (by FUJIFILM, having Re/Rth=50/125 at 550 nm) that had been alkali-saponified in the same manner as above were stuck together via the polarizing film sandwiched therebetween in a manner so that the saponified surfaces of the two faced the polarizing film, thereby producing a polarizing plate A, in which the film TD80UL and the retardation film for VA-mode serve as the protective film for the polarizing film therein. The films were combined so that the slow axis of the VA-mode retardation film was perpendicular to the absorption axis of the polarizing film.

<Production of Polarizing Plate A with Optical Film A>

The transparent support A side of the optical film A produced in the above and the TD80UL side of the polarizing plate A were stuck together using an adhesive, thereby producing a polarizing plate A with optical film A. In this, the films were combined so that the slow axis of the patterned optically-anisotropic layer A was at an angle of ±45 degrees to the absorption axis of the polarizing film.

### <Production of 3D Display Device A>

The polarizing plate on the viewers' side was peeled from Nanao's FlexScan S2231W, and the VA-mode retardation film of the polarizing plate A with optical film A produced in the above was stuck to the LC cell using an adhesive. Subsequently, the polarizing plate on the light source side was peeled, and the VA-mode retardation film of the polarizing plate A was stuck to the LC cell using an adhesive. According to this process, a 3D display device A having the configuration as in FIG. 6(a) was produced. The direction of the absorption axis of the polarizing film is the same as in FIG. 3.

### Example 2

### Formation of Patterned Optically-Anisotropic Layer B

A patterned optically-anisotropic layer B was formed on the transparent support B according to the same method as in Example 1 except that the transparent support A was changed to the transparent support B. The thickness of the optically-anisotropic layer was 1.3 micro meters.

### (Evaluation of Optically-Anisotropic Layer B)

From the results in Table 2, it is understood that, when a rod-shaped liquid crystal is aligned on an photo-alignment layer that has been mask-exposed through polarization, in the presence of a horizontally-aligning agent, then there is formed a patterned optically-anisotropic layer having a first retardation domain and a second retardation domain in which the liquid crystal is horizontally aligned and the slow axes of the two domains are perpendicular to each other.

### <Production of Optical Film B>

In the same manner as in Example 1, an antireflection layer was formed on the film having the patterned optically-anisotropic layer B on the transparent support B, on the side of the transparent support B thereof on which the optically-anisotropic layer was not formed, thereby producing an optical film B.

<Production of Polarizing Plate B with Optical Film B>

The patterned optically-anisotropic layer B side of the optical film B produced in the above and the TD80UL side of the polarizing plate A produced in Example 1 were stuck together using an adhesive, thereby producing a polarizing plate B with optical film B. In this, the films were combined so that the slow axis of the patterned optically-anisotropic layer B was at an angle of ±45 degrees to the absorption axis of the polarizing film.

### <Production of 3D Display Device B>

The polarizing plate on the viewers' side was peeled from Nanao's FlexScan S2231W, and the VA-mode retardation film of the polarizing plate B with optical film B produced in the above was stuck to the LC cell using an adhesive. Subsequently, the polarizing plate on the light source side was peeled, and the VA-mode retardation film of the polarizing plate A was stuck to the LC cell using an adhesive. According to this process, a 3D display device B having the configuration as in FIG. 6(b) was produced. The direction of the absorption axis of the polarizing film is the same as in FIG. 3.

### Example 3

### Production of Transparent Support C

The following ingredients were put into a mixing tank and dissolved by stirring under heat, thereby preparing a cellulose acylate solution.

Formulation of Cellulose Acylate Solution

| | |
|---|---|
| Cellulose acylate having a degree of acetylation | 100 parts by mass |
| of from 60.7 to 61.1% | |
| Triphenyl phosphate (plasticizer) | 7.8 parts by mass |
| Biphenyldiphenyl phosphate (plasticizer) | 3.9 parts by mass |
| Methylene chloride (first solvent) | 336 parts by mass |
| Methanol (second solvent) | 29 parts by mass |
| 1-Butanol (third solvent) | 11 parts by mass |

16 parts by mass of a retardation enhancer (A) mentioned below, 92 parts by mass of methylene chloride and 8 parts by mass of methanol were put into a different mixing tank and dissolved by stirring under heat, thereby preparing a retardation enhancer solution. 25 parts by mass of the retardation enhancer was added to 474 parts by mass of the cellulose acetate solution and fully stirred to prepared a dope. The amount of the retardation enhancer added was 6.0 parts by mass relative to 100 parts by mass of the cellulose acetate.

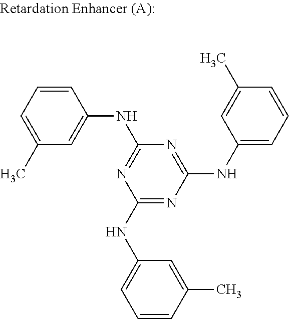 [SMILES: Cc1cccc(Nc2nc(Nc3cccc(C)c3)nc(Nc3cccc(C)c3)n2)c1]

The obtained tope was cast, using a band stretcher. After the film surface temperature on the band reached 40 degrees Celsius, the film on the band was dried with hot air at 70 degrees Celsius for 1 minute and then dried with dry air at 140 degrees Celsius for 10 minutes, and then peeled to give a transparent support C having a residual solvent amount of 0.3% by mass.

The thickness of the obtained transparent support C was 80 micro meters. Retardation in-plane (Re) of the support was 8 nm and retardation along the thickness-direction (Rth) thereof was 78 nm.

### <Formation of Patterned Optically-Anisotropic Layer C>

A patterned optically-anisotropic layer C was formed according to the same operation as in Example 1 except that the transparent support A was changed to the above-mentioned transparent support C. The thickness of the optically-anisotropic layer was 1.3 micro meters.

### (Evaluation of Optically-Anisotropic Layer C)

From the results in Table 2, it is understood that, when a rod-shaped liquid crystal is aligned on an photo-alignment layer that has been mask-exposed through polarization, in the presence of a horizontally-aligning agent, then there is formed a patterned optically-anisotropic layer having a first retardation domain and a second retardation domain in which the liquid crystal is horizontally aligned and the slow axes of the two domains are perpendicular to each other.

### <Production of Polarizing Plate C>

A roll of polyvinyl alcohol film having a thickness of 80 micro meters was unrolled and continuously stretched by 5 times in an aqueous iodine solution and dried to give a polarizing film having a thickness of 20 micro meters. According to the same method as in Example 1, the transparent support C side of the film having the patterned optically-anisotropic layer C on the transparent support C was alkali-saponified, and stuck to a VA-mode retardation film (by FUJIFILM, having a ratio of Re/Rth=50/125 at 550 nm) that had been alkali-saponified in the same manner, using an adhesive via the polarizing film sandwiched therebetween, thereby producing a polarizing plate C, in which the VA-mode retardation film and the transparent support C serve as the protective film for the polarizing film therein. The films were combined so that the slow axis of the VA-mode retardation film was perpendicular to the absorption axis of the polarizing film, and the slow axis of the patterned optically-anisotropic layer C disposed on the other surface of the polarizing film was at an angle of ±45 degrees to the absorption axis of the optically-anisotropic layer C.

<Production of Polarizing Plate C with Surface Film B>

### <<Preparation of Cellulose Acylate>>

A cellulose acylate having a total degree of substitution of 2.97 (the breakdown is: a degree of acetyl substitution of 0.45 and a degree of propionyl substitution of 2.52). As a catalyst, a mixture of sulfuric acid (7.8 parts by mass relative to 100 parts by mass of cellulose) and a carboxylic acid anhydride was cooled at −20 degrees Celsius, and added to pulp-derived cellulose for acylation thereof at 40 degrees Celsius. At that time, the type and the amount of the carboxylic acid anhydride were varied and controlled to thereby change and control the type of the acyl group and the degree of substitution with the group. After the acylation, the ester was ripened at 40 degrees Celsius to control the total degree of substitution thereof.

### <<Preparation of Cellulose Acylate Solution>>

### 1) Cellulose Acylate:

The prepared cellulose acylate was heated at 120 degrees Celsius and dried to have a water content of at most 0.5% by mass, and 30 parts by mass of the acylate was mixed with a solvent.

### 2) Solvent:

Dichloromethane/methanol/butanol (81/15/4 parts by mass) was used as the solvent. The water content of each solvent was at most 0.2% by mass.

### 3) Additive:

0.9 parts by mass of trimethylolpropane triacetate was added in preparing all solutions. In addition, 0.25 parts by mass of silicon dioxide fine particles (particle size, 20 nm; Mohs hardness, about 7) were added in preparing all solutions.

### 4) Welling, Dissolution:

The above-mentioned solvent and additive were put into a 400-liter stainless dissolver equipped with a stirring blade, and cooling water was kept circulated around the outer peripheral surface of the dissolver. With stirring and dispersing them, the above-mentioned cellulose acylate was gradually added thereto. After the addition, this was stirred at room temperature for 2 hours, then kept swelling for 3 hours, and again stirred thereby to prepare a cellulose acylate solution.

For the stirring, used were a dissolver-type eccentric stirring shaft stirring at a peripheral speed of 15 m/sec (shearing stress 5×10⁴ kgf/m/sec²) and a stirring shaft equipped with an anchor blade a the center axis thereof and stirring at a peripheral speed of 1 m/sec (shearing stress 1×10⁴ kgf/m/sec²). For the swelling, the high-speed stirring shaft was stopped and the peripheral speed of the stirring shaft equipped with an anchor blade was controlled at 0.5 m/sec.

### 5) Filtration:

The cellulose acylate solution prepared in the above was filtered through a paper filter having an absolute filtration accuracy of 0.01 mm (#63 by Toyo Filter), and further through a paper filter having an absolute filtration accuracy of 2.5 micro meters (FH025, by Paul) to give the cellulose acylate solution for use herein.

### <<Production of Transparent Support D>>

The above cellulose acylate solution was heated at 30 degrees Celsius, and cast onto a mirrored stainless support having a band length of 60 m set at 15 degrees Celsius via a casting die (described in JP-A 11-314233). The casting speed was 15 m/min, and the coating width was 200 cm. The spatial temperature of the entire casting part was set at 15 degrees Celsius. At 50 cm before the casting part, the cast and rotating cellulose acylate film was peeled from the band, and given dry air at 45 degrees Celsius. Next, this was dried at 110 degrees Celsius for 5 minutes and then 140 degrees Celsius for 10 minutes, thereby giving a cellulose acylate film transparent support D (having a thickness of 41 micro meters).

The transparent support D did not contain a UV absorbent, and Re thereof was 0 nm and Rth thereof was −40 nm.

The transparent support D was used as a surface film support; and in the same manner as in Example 1, a surface film B was formed on the surface film support D.

The transparent support D side of the surface film B was stuck to the patterned optically-anisotropic layer C side of the polarizing plate C, using an adhesive to produce a polarizing plate C with surface film B.

### <Production of 3D Display Device C>

The polarizing plate on the viewers' side was peeled from Nanao's FlexScan S2231W, and the VA-mode retardation film of the polarizing plate C with surface film B produced in the above was stuck to the LC cell using an adhesive. Subsequently, the polarizing plate on the light source side was peeled, and the VA-mode retardation film of the polarizing plate A was stuck to the LC cell using an adhesive. According to this process, a 3D display device C having the configuration as in FIG. 6(c) was produced. The direction of the absorption axis of the polarizing film was the same as in FIG. 3.

### Example 4

### Production of Transparent Support with Photo-Alignment Layer

A polarizing plate D with optical film D was produced according to the same method for the polarizing plate B with optical film B, except that, in producing the polarizing plate B with optical film B, the transparent support B of the optical film B was changed to TD80UL (by FUJIFILM, having Re/Rth=2/40 at 550 nm), TD80UL of the polarizing plate B was changed to the transparent support B, the VA-mode retardation film was changed to WV-EA (by FUJIFILM), and the polarization exposure method for the photo-alignment layer was changed as follows. Regarding the polarization exposure for the photo-alignment layer, a wire grid polarizing element (Moxtek's ProFlux PPL02) was set parallel to the stripes of the mask, and the film was exposed through the mask A (stripe mask having a lateral stripe width in the transmitting part of 285 micro meters and a lateral stripe width in the blocking part of 285 micro meters). Subsequently, the wire grid polarizing element was set vertically to the stripes, and the film was photoexposed via the mask B (stripe mask having a lateral stripe width in the transmitting part of 285 micro meters and a lateral stripe width in the blocking part of 285 micro meters).

The angle between the slow axis of the patterned optically-anisotropic layer and the absorption axis of the polarizing film was ±45 degrees.

### <Production of 3D Display Device D>

The patterned retardation plate and the front retardation plate were peeled from a circularly-polarized glasses-use 3D monitor W220S (by Hyundai), and the polarizing plate produced in the above was stuck thereto to thereby produce a 3D display device D having the configuration of FIG. 6(b). The direction of the absorption axis of the polarizing film was the same as in FIG. 2.

### Example 5

### Production of Transparent Support with Rubbed Alignment Layer

### (1) Formation of Parallel Alignment Layer (First Alignment Layer):

Using a bar #12, a 4% water/methanol solution of Kuraray's polyvinyl alcohol, “PVA103” (prepared by dissolving PVA103 (4.0 g) in water (72 g) and methanol (24 g), and having a viscosity of 4.35 cp and a surface tension of 44.8 dyne) was applied to the saponified surface of the transparent support B produced in Example 1, and dried at 80 degrees Celsius for 5 minutes.

### (2) Formation of Patterned Vertical Alignment Layer (Second Alignment Layer):

2.0 g of an alignment layer polymer A (Mw 25000) mentioned below was dissolved in water (1.12 g)/propanol (5.09 g)/3-methoxy-1-butanol (5.09 g) to prepare a coating liquid.

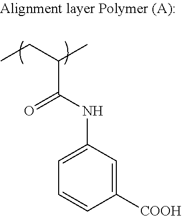

Next, a synthetic rubber flexographic plate having a patterned indented surface as in FIG. 7 was produced.

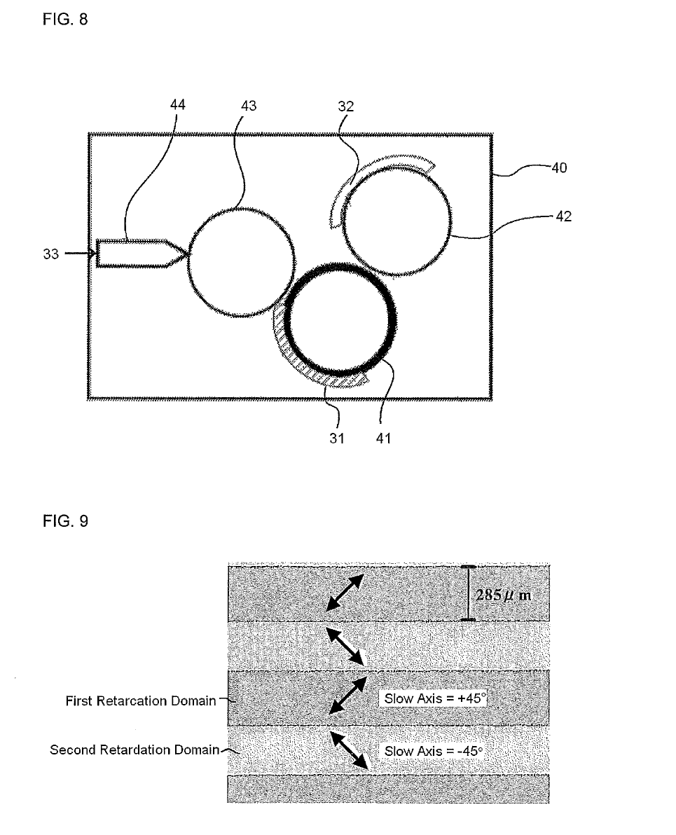

As a flexographic printing apparatus shown in FIG. 8, used was Flexiproof 100 (by RK Print Coat Instruments Ltd. UK). The anilox roller used here had a line screen of 400 cells/cm (capacity 3 cm³/m²). The flexographic plate was stuck to the impression cylinder of Flexiproof 100 using a pressure-sensitive tape. The parallel alignment layer was stuck to the pressure roller, the coating liquid for patterned vertical alignment layer was put into a doctor blade, and a vertical alignment layer was pattern-printed on the parallel alignment layer at a printing speed of 30 m/min.

### (3) Formation of Rubbed Alignment Layer:

After dried at 80 degrees Celsius for 5 minutes, the film was rubbed once back and force in the direction parallel to the stripe lines of the pattern, at 1000 rpm, thereby forming a rubbed alignment layer.

### <Formation of Patterned Optically-Anisotropic Layer E>

The coating liquid for optically-anisotropic layer prepared in Example 1 was applied onto the transparent support B, and dried at a film surface temperature of 105 degrees Celsius for 1 minute to form a liquid-crystal phase state, and thereafter cooled to 75 degrees Celsius, and in air this was exposed to UV rays, using a 160 W/cm, air-cooled metal halide lamp (by Eye Graphics), to thereby fix the alignment state to form a patterned optically-anisotropic layer E. The thickness of the optically-anisotropic layer was 1.3 micro meters.

### (Evaluation of Optically-Anisotropic Layer)

The formed optically-anisotropic layer was peeled from the transparent support B, and then, in the same manner as in Example 1, the direction of the slow axis of the optically-anisotropic layer was determined. Table 2 shows the relationship between the slow axis of the optically-anisotropic layer and the rubbing direction of the alignment layer. The results in Table 2 confirm the following: When a rod-shaped liquid crystal is aligned and photoexposed on a PVA-base unidirectionally-rubbed alignment layer (first alignment layer)/alignment layer polymer A-base rubbed alignment layer (second alignment layer), then a patterned optically-anisotropic layer having a first retardation domain and a second retardation domain is formed in which the liquid crystal is horizontally aligned and the slow axes of the two domains are perpendicular to each other.

### <Production of Optical Film E>

According to the same method as in Example 1, an antireflection film was formed on the surface of the transparent support B of the patterned optically-anisotropic layer E, thereby producing an optical film E.

<Production of Polarizing Plate E with Optical Film E>

The surface of WV-EA (by FUJIFILM) was alkali-saponified. Briefly, the film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath, and dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using an aqueous 3% solution of polyvinyl alcohol (Kuraray's PVA-117H) as the adhesive, the alkali-saponified WV-EA was stuck to one side of the polarizing film in a manner so that the saponified side of the former faced the polarizing film side, and the patterned optically-anisotropic layer E side of the optical film E was stuck to the other side of the polarizing film with the adhesive. Accordingly, a polarizing plate E was produced having WV-EA and the optical film E both serving as a protective film for the polarizing film therein. In this, the films were combined so that the slow axis of the patterned optically-anisotropic layer was at an angle of ±45 degrees to the absorption axis of the polarizing film.

### <Production of 3D Display Device E>

The patterned retardation plate and the front retardation plate were peeled from a circularly-polarized glasses-use 3D monitor W220S (by Hyundai), and the polarizing plate produced in the above was stuck thereto to thereby produce a 3D display device F having the configuration of FIG. 6(d). The direction of the absorption axis of the polarizing film was the same as in FIG. 2.

### Example 6

### Production of Transparent Support with Rubbed Alignment Layer

Using a bar #12, an aqueous solution of 4% polyvinyl alcohol, Kuraray's “PVA103” was applied to the surface of a film, Teijin's Pure Ace having Re(550) of 138 nm and Rth(550) of 69 nm, and dried at 80 degrees Celsius for 5 minutes. Subsequently, this was rubbed once back and forth in the direction parallel to the slow axis of Pure Ace at 400 rpm, thereby producing a transparent support with a rubbed alignment layer. The thickness of the alignment layer was 0.5 micro meters.

### <Formation of Patterned Optically-Anisotropic Layer G>

The composition for optically-anisotropic layer prepared in Example 1 was filtered through a polypropylene filter having a pore size of 0.2 micro meters, and this was used here as a coating liquid for ½ wavelength layer. The coating liquid was applied, and dried at a film surface temperature of 105 degrees Celsius for 1 minute to form a uniformly-aligned liquid-crystal phase state, and thereafter cooled to 75 degrees Celsius. Next, a mask having a lateral stripe width of 285 micro meters was disposed on the substrate coated with the coating liquid for ½ wavelength layer, and in air this was exposed to UV rays for 5 seconds, using an air-cooled metal halide lamp (by Eye Graphics) having a lighting intensity of 20 mW/cm², to thereby fix the alignment state to form a first retardation domain. Subsequently, this was heated up to a film surface temperature of 130 degrees Celsius so as to once form an isotropic phase, then irradiated with 20 mW/cm² on the entire surface thereof for 20 seconds, to thereby fix the alignment state to form a second retardation domain. In that manner, a patterned ½ wavelength layer was formed. The mask was disposed so that the stripe direction was parallel to the rubbing direction. It was confirmed that thickness of the layer was 2.7 micro meters, and the tilt angle thereof was around 0°. Separately, the same optically-anisotropic layer was formed on a glass substrate, and Re thereof at a wavelength of 550 nm was measured. As a result, Re of the first retardation domain was 275 nm, the slow axis thereof was parallel to the slow axis of Pure Ace, and Re of the second retardation domain was 0 nm. The total of Re of the first retardation domain of the patterned optically-anisotropic layer G and Re of the transparent support was 413 nm, the total of Re of the second retardation domain and Re of the transparent support was 138 nm, and the slow axis of the first retardation domain was parallel to the slow axis of the second retardation domain.

### <Production of Optical Film G>

In the above-mentioned film A, two transparent supports B were layered and the transparent support B side and the optically-anisotropic layer side of he patterned optically-anisotropic layer G were stuck together using an adhesive, thereby producing an optical film G.

### <Production of Polarizing Plate G>

The support surface of WV-EA (by FUJIFILM) was alkali-saponified. Briefly, the film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath, and dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using an aqueous 3% solution of polyvinyl alcohol (Kuraray's PVA-117H) as the adhesive, the alkali-saponified WV-EA was stuck to one side of the polarizing film in a manner so that the saponified support side of the former faced the polarizing film side, and the support side of the optical film G was stuck to the other side of the polarizing film with the adhesive. Accordingly, a polarizing plate G was produced having WV-EA and the optical film G both serving as a protective film for the polarizing film therein. In this, the films were combined so that the slow axis of the patterned optically-anisotropic layer G was at an angle of 45 degrees to the absorption axis of the polarizing film.

### <Production of 3D Display Device G>

The patterned retardation plate and the front retardation plate were peeled from a circularly-polarized glasses-use 3D monitor W220S (by Hyundai), and the polarizing plate produced in the above was stuck thereto to thereby produce a 3D display device G having the configuration of FIG. 6(c). The direction of the absorption axis of the polarizing film is the same as in FIG. 2.

### Example 7

### Formation of Patterned Optically-Anisotropic Layer J

An optically-anisotropic layer J was formed according to the same method as in Example 6 except that the mask was disposed so that the stripe direction was at 45° to the rubbing direction.

### <Production of Optical Film J>

An optical film J was produced according to the same method as in Example 6 except that one transparent support B was used in place of using two transparent supports B as laminated.

### <Production of Polarizing Plate J>

A polarizing plate J was produced in the same manner as that for the polarizing plate G except that a VA-mode retardation film (by FUJIFILM, having Re/Rth=50/125 at 550 nm) was used in place of WV-EA (by FUJIFILM).

### <Production of 3D Display Device J>

The polarizing plate on the viewers' side was peeled from Nanao's FlexScan S2231W, and the VA-mode retardation film of the polarizing plate J produced in the above was stuck to the LC cell using an adhesive. Subsequently, the polarizing plate on the light source side was peeled, and the VA-mode retardation film of the polarizing plate A was stuck to the LC cell using an adhesive. According to this process, a 3D display device J having the configuration as in FIG. 6(c) was produced.

### Comparative Example 1

### Production of Transparent Support K with Photo-Alignment Layer

A 3D display device K was produced, using the rod-shaped liquid crystal and the alignment layer described in WO2010/090429.

An aqueous 1% solution of an optically-aligning material E-1 having the structure mentioned below was applied onto the saponified surface of TD80UL (by FUJIFILM, having Re/Rth=2/40 at 550 nm), and dried at 100 degrees Celsius for 1 minute. The formed coating film was irradiated with UV rays in air, using an air-cooled metal halide lamp (by Eye Graphics) having a lighting intensity of 160 W/cm². In this step, a wire grid polarizing element (Moxtek's ProFlux PPL02) was set in the direction 1 as in FIG. 10(a), and the layer was photoexposed via the mask A (stripe mask having a lateral stripe width in the transmitting part of 285 micro meters and a lateral stripe width in the blocking part of 285 micro meters). Subsequently, the wire grid polarizing element was set in the direction 2 as in FIG. 10(b), and the layer was photoexposed via the mask B (stripe mask having a lateral stripe width in the transmitting part of 285 micro meters and a lateral stripe width in the blocking part of 285 micro meters). The distance between the photoexposure mask and the photo-alignment layer was 200 micro meters. The lighting intensity of UV rays used in the case was 100 mW/cm² in the UV-A region (integration at a wavelength of from 380 nm to 320 nm), and the irradiation dose was 1000 mJ/cm² in the UV-A region.

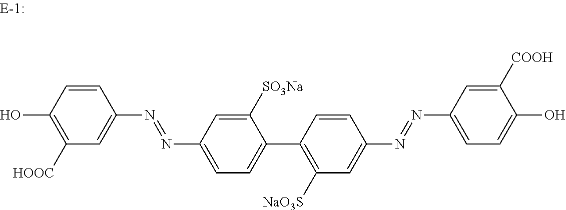

### <Formation of Patterned Optically-Anisotropic Layer K>

The composition for optically-anisotropic layer mentioned below was prepared, and filtered through a polypropylene filter having a pore size of 0.2 micro meters to prepare a coating liquid for use herein. The coating liquid was applied onto the transparent support K with a photo-alignment layer, and dried at a film surface temperature of 105 degrees Celsius for 2 minutes to form a liquid-crystal phase state, and thereafter cooled to 75 degrees Celsius. In air, this was exposed to UV rays, using an air-cooled metal halide lamp (by Eye Graphics) having a lighting intensity of 160 W/cm², to thereby fix the alignment state to form a patterned optically-anisotropic layer K. The thickness of the optically-anisotropic layer was 1.3 micro meters.

Composition for Optically-Anisotropic Layer

| | |
|---|---|
| Rod-shaped liquid crystal (LC242, by BASF) | 100 parts by mass |
| Horizontally aligning agent A | 0.3 parts by mass |
| Photopolymerization initiator (Irgacure 907, by | 3.3 parts by mass |
| Ciba Specialty Chemicals) | |
| Sensitizer (Kayacure DETX, by Nippon Kayaku) | 1.1 parts by mass |
| Methyl ethyl ketone | 300 parts by mass |

### Rod-Shaped Liquid Crystal LC242: Rod-Shaped Liquid Crystal Described in WO2010/090429A2:

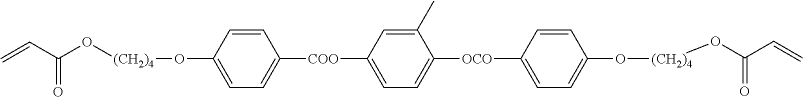

### Horizontally-Aligning Agent A:

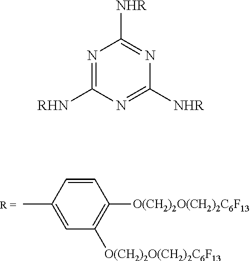

### (Evaluation of Optically-Anisotropic Layer)

The formed optically-anisotropic layer was peeled from TD80UL, and then, in the same manner as in Example 1, the direction of the slow axis of the optically-anisotropic layer was determined. Table 2 shows the relationship between the slow axis of the optically-anisotropic layer and the photoexposure direction of the alignment layer. The results in Table 2 confirm the following: When a rod-shaped liquid crystal is aligned and photoexposed on an photo-alignment layer, then a patterned optically-anisotropic layer having a first retardation domain and a second retardation domain is formed in which the liquid crystal is horizontally aligned and the slow axes of the two domains are perpendicular to each other.

### <Production of Optical Film K>

According to the same method as in Example 1, an antireflection film was formed on TD80UL having the patterned optically-anisotropic layer K, on the surface thereof not having the optically-anisotropic layer, thereby producing an optical film K.

<Production of Polarizing Plate A with Optical Film K>

The patterned optically-anisotropic layer K side of the optical film K produced in the above and the TD80UL side of the polarizing plate A produced in Example 1 were stuck together with an adhesive, thereby producing a polarizing plate A with optical film K. In this, the films were combined so that the slow axis of the patterned optically-anisotropic layer K was at an angle of ±45 degrees to the absorption axis of the polarizing film.

### <Production of 3D Display Device K>

The polarizing plate on the viewers' side was peeled from Nanao's FlexScan S2231W, and the VA-mode retardation film of the polarizing plate A with optical film K produced in the above was stuck to the LC cell using an adhesive, thereby producing a 3D display device K having the configuration as in FIG. 6(b). The direction of the transmission axis of the polarizing film is the same as in FIG. 3.

### Comparative Example 2

### Formation of Patterned Optically-Anisotropic Layer I

A film having a patterned optically-anisotropic layer I was formed on TD80UL according to the same method as in Comparative Example 1 except that in the production of the patterned optically-anisotropic layer K in Comparative Example 1, the wire grid polarizing element was set in parallel to the stripe of the mask. The thickness of the optically-anisotropic layer was 1.3 micro meters.

### <Production of Optical Film I>

The transparent support B of the surface film A produced in Example 1 was changed to a commercial cellulose acetate film TD80UL (by FUJIFILM, having Re/Rth=2/40 at 550 nm) and the TD80UL film was stuck to the optically-anisotropic layer K side of the film TD80UL on which the patterned optically-anisotropic layer K had been formed in the same manner as above, using an adhesive, thereby producing an optical film I.

### <Production of Polarizing Plate I>

TD80UL (by FUJIFILM, having Re/Rth=2/40 at 550 nm) and WV-EA (by FUJIFILM) were used as a protective film for polarizing plate I. Their surfaces were alkali-saponified. Briefly, the film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath and then dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using an aqueous 3% solution of polyvinyl alcohol (Kuraray's PVA-117H) as the adhesive, the alkali-saponified TD80UL was stuck to WV-EA of which the support side had been alkali-saponified with the polarizing film kept sandwiched therebetween in a manner so that the saponified surfaces faced the polarizing film, thereby producing a polarizing plate I in which TD80UL and WV-EA both serve as a protective film for the polarizing film therein.

<Production of Polarizing Plate I with Optical Film I>

The TD80UL side of the optical film I produced in the above and the TD80UL side of the polarizing plate I were stuck together with an adhesive to produce a polarizing plate I with optical film I. In this, the films were combined so that the slow axis of the patterned optically-anisotropic layer was at an angle of ±45 degrees to the absorption axis of the polarizing film.

### <Production of 3D Display Device I>

The patterned retardation plate and the front polarizing plate were peeled from a circularly-polarized glasses-use 3D monitor W220S (by Hyundai), and the polarizing plate I produced in the above was stuck thereto to thereby produce a 3D display device I having the configuration of FIG. 6(a). The direction of the transmission axis of the polarizing film was the same as in FIG. 2.

### Example 8

A 3D display device A′ was produced according to the same method as that for the 3D display device A, except that the transparent support A and TD80UL existing between the polarizing film of the front polarizing plate and the patterned optically-anisotropic layer were both changed to Z-TAC (by FUJIFILM, having Re/Rth=−1/−1 at 550 nm).

### Example 9

### Production of Transparent Support L

A transparent support L was produced according to the same method as that for the production of the transparent support D, except that in dissolving cellulose acylate in the solvent, 3.0% of the following UV absorbent A was put into the system along with cellulose acylate, and stirred and dispersed. Re(550) of the obtained transparent support L was 0 nm, and Rth(550) thereof was −75 nm.

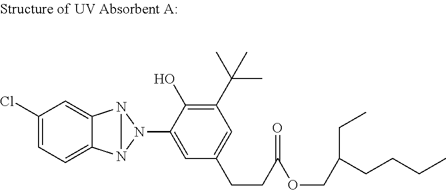 [SMILES: CCCCC(CC)COC(=O)CCc1cc(-n2n3c4ccc(Cl)cc4n23)c(O)c(C(C)(C)C)c1]

A 3D display device A″ was produced according to the same method as that for the 3D display device A, except that the transparent support B of the surface film A was changed to the transparent support L.

### Example 10

A 3D display device B′ was produced according to the same method as in Example 2, except that TD80UL existing between the polarizing film of the front polarizing plate and the patterned optically-anisotropic layer in the 3D display device B produced in the above was changed to Z-TAC (by FUJIFILM, having Re/Rth=−1/−1 at 550 nm).

### Example 11

A 3D display device C′ was produced according to the same method as above, except that the transparent support C existing between the polarizing film of the front polarizing plate and the patterned optically-anisotropic layer in the 3D display device C produced in the above was changed to Z-TAC (by FUJIFILM, having Re/Rth=−1/−1 at 550 nm).

### Comparative Example 3

A 3D display device D′ was produced according to the same method as above, except that the transparent support B existing between the polarizing film of the front polarizing plate and the patterned optically-anisotropic layer in the 3D display device D produced in the above was changed to Z-TAC (by FUJIFILM, having Re/Rth=−1/−1 at 550 nm).

Table 2 collectively shows the physical dada of the optically-anisotropic layer in Examples 1 to 11 and Comparative Examples 1 to 3; and Tables 3 and 4 collectively show the retardation data of the members disposed on the viewing side than the polarizing film.

TABLE 2

| | | | | | | | | | | Optical | |
|---|---|---|---|---|---|---|---|---|---|---|---|
| | | | | | | | | | | Characteristics | |
| | | | | | Patterning | | Slow Axis | | | of Optically- | |
| | | | Horizontally-Aligning Agent | | | Direction | Direction | Tilt Angle | | Anisotropic Layer | |
| | Liquid | Alignment | | Amount Added | | (relative | (relative | Alignment | Air-Side | Re | Rth |
| | Crystal | layer | Material | (part by mass) | Method | to stripe) | to stripe) | layer Side | Interface | (nm) | (nm) |
| Example 1 | LC242 | E-1 | A | 0.3 | polarization | +45° | −45° | horizontal | horizontal | 130 | 65 |
| | | | | | exposure | −45° | +45° | horizontal | horizontal | 130 | 65 |
| Example 8 | LC242 | E-1 | A | 0.3 | polarization | +45° | −45° | horizontal | horizontal | 130 | 65 |
| | | | | | exposure | −45° | +45° | horizontal | horizontal | 130 | 65 |
| Example 9 | LC242 | E-1 | A | 0.3 | polarization | +45° | −45° | horizontal | horizontal | 130 | 65 |
| | | | | | exposure | −45° | +45° | horizontal | horizontal | 130 | 65 |
| Example 2 | LC242 | E-1 | A | 0.3 | polarization | +45° | −45° | horizontal | horizontal | 130 | 65 |
| | | | | | exposure | −45° | +45° | horizontal | horizontal | 130 | 65 |
| Example 10 | LC242 | E-1 | A | 0.3 | polarization | +45° | −45° | horizontal | horizontal | 130 | 65 |
| | | | | | exposure | −45° | +45° | horizontal | horizontal | 130 | 65 |
| Example 3 | LC242 | E-1 | A | 0.3 | polarization | +45° | −45° | horizontal | horizontal | 130 | 65 |
| | | | | | exposure | −45° | +45° | horizontal | horizontal | 130 | 65 |
| Example 11 | LC242 | E-1 | A | 0.3 | polarization | +45° | −45° | horizontal | horizontal | 130 | 65 |
| | | | | | exposure | −45° | +45° | horizontal | horizontal | 130 | 65 |
| Example 7 | LC242 | PVA103 | A | 0.3 | 105° C. | — | +45° | horizontal | horizontal | 275 | 137 |
| | | | | | 130° C. | | −45° | horizontal | horizontal | 0 | 0 |
| Comparative | LC242 | E-1 | A | 0.3 | — | +45° | −45° | horizontal | horizontal | 130 | 65 |
| Example 1 | | | | | | −45° | +45° | horizontal | horizontal | 130 | 65 |
| Example 4 | LC242 | E-1 | A | 0.3 | polarization | 0° | +90° | horizontal | horizontal | 130 | 65 |
| | | | | | exposure | +90° | 0° | horizontal | horizontal | 130 | 65 |
| Comparative | LC242 | E-1 | A | 0.3 | polarization | 0° | +90° | horizontal | horizontal | 130 | 65 |
| Example 3 | | | | | exposure | +90° | 0° | horizontal | horizontal | 130 | 65 |
| Example 5 | LC242 | PVA103 | A | 0.3 | 105° C. | — | 0° | horizontal | horizontal | 130 | 65 |
| | | Polymer A | | | 105° C. | | +90° | horizontal | horizontal | 130 | 65 |
| Example 6 | LC242 | PVA103 | A | 0.3 | 105° C. | — | 0° | horizontal | horizontal | 275 | 137 |
| | | | | | 130° C. | | 0° | horizontal | horizontal | 0 | 0 |
| Comparative | LC242 | E-1 | A | 0.3 | polarization | 0° | +90° | horizontal | horizontal | 130 | 65 |
| Example 2 | | | | | exposure | +90° | 0° | horizontal | horizontal | 130 | 65 |

TABLE 3
Examples and Comparative Example of VA-Mode Liquid-Crystal Display Device

| | | | | | | Rth(nm) | | | | | | |
|---|---|---|---|---|---|---|---|---|---|---|---|---|
| | | | | | | | | | | | Total of | |
| | | | | | | | | | | | Layers on | |
| | Re(nm) | | | | | | | | Surface | | the viewing | |
| | Protective | | | | | Protective | | | Film | | side than | |
| | Film for | Trans- | Optically- | Surface | | Film for | Trans- | Optically- | Support | | the optically- | |
| | Polarizing | parent | Anisotropic | Film | | Polarizing | parent | Anisotropic | (substrate | | anisotropic | |
| | Film | Support | Layer | Support | Total | Film | Support | Layer | film) | Total | layer | Mode |
| Example 1 | 2 | 0 | 130/130 | 0 | 132/132 | 40 | 12.3 | 65/65 | −75 | 42.3/42.3 | −10/−10 | VA |
| Example 8 | −1 | −1 | 130/130 | 0 | 128/128 | −1 | −1 | 65/65 | −75 | −12/−12 | −10/−10 | VA |
| Example 9 | 2 | 0 | 130/130 | 0 | 132/132 | 40 | 12.3 | 65/65 | −75 | 42.3/42.3 | −10/−10 | VA |
| Example 2 | 2 | — | 130/130 | 0 *2 | 132/132 | 40 | — | 65/65 | −75 *2 | 30/30 | −10/−10 | VA |
| Example 10 | −1 | — | 130/130 | 0 *2 | 129/129 | −1 | — | 65/65 | −75 *2 | −11/−11 | −10/−10 | VA |
| Example 3 | — | 8 | 130/130 | 0 | 138/138 | — | 78 | 65/65 | −40 | 103/103 | 25/25 | VA |
| Example 11 | — | −1 | 130/130 | 0 | 129/129 | — | −1 | 65/65 | −40 | 24/24 | 25/25 | VA |
| Example 7 | — | 138 | 275/0 | 0 | 413/138 | — | 69 | 137/0 | −75 | 131/−6 | 62/−75 | VA |
| Comparative | 2 | — | 130/130 | 2 *2 | 134/134 | 40 | — | 65/65 | 40 *2 | 145/145 | 105/105 | VA |
| Example 1 | | | | | | | | | | | | |

*1: T The values shown in the column “Optically-anisotropic layer” or the column “total” indicate “the value of first retardation domain/the value of second retardation domain”.
*2: The data are Re and Rth of the film used as the support for both the optically-anisotropic layer and the antireflection film in the production process, and for convenience' sake, the column of “transparent support” of the optically-anisotropic layer was in blank and the data are given in the column of “Surface film support”.

TABLE 4
Examples and Comparative Example of TN-Mode Liquid-Crystal Display Device

| | | | | | | Rth(nm) | | | | | | |
|---|---|---|---|---|---|---|---|---|---|---|---|---|
| | | | | | | | | | | | Total of | |
| | | | | | | | | | | | Layers on | |
| | Re(nm) | | | | | | | | Surface | | the viewing | |
| | Protective | | | | | Protective | | | Film | | side than | |
| | Film for | Trans- | Optically- | Surface | | Film for | Trans- | Optically- | Support | | the optically- | |
| | Polarizing | parent | Anisotropic | Film | | Polarizing | parent | Anisotropic | (substrate | | anisotropic | |
| | Film | Support | Layer | Support | Total | Film | Support | Layer | film) | Total | layer | Mode |
| Example 4 | 0 | — | 130/130 | 2 *2 | 132/132 | −75 | — | 65/65 | 40 *2 | 30/30 | 105/105 | TN |
| Comparative | −1 | — | 130/130 | 2 *2 | 131/131 | −1 | — | 65/65 | 40 *2 | 104/104 | 105/105 | TN |
| Example 3 | | | | | | | | | | | | |
| Example 5 | — | — | 130/130 | 0 *2 | 130/130 | — | — | 65/65 | −75 *2 | −10/−10 | −10/−10 | TN |
| Example 6 | — | 138 | 275/0 | 0 *3 | 413/138 | — | 69 | 137/0 | −150 *3 | 56/−81 | −13/−150 | TN |
| Comparative | 2 | 2 | 130/130 | 2 | 136/136 | 40 | 40 | +65/+65 | 40 | 185/185 | 105/105 | TN |
| Example 2 | | | | | | | | | | | | |

*1: T The values shown in the column “Optically-anisotropic layer” or the column “total” indicate “the value of first retardation domain/the value of second retardation domain”.
*2: The data are Re and Rth of the film used as the support for both the optically-anisotropic layer and the antireflection film in the production process, and for convenience' sake, the column of “transparent support” of the optically-anisotropic layer was in blank and the data are given in the column of “Surface film support”.
*3: The surface film support has a two-layered structure, and the total of Rth of the support is shown.

### (Evaluation)

### <Evaluation of 3D Display Device>

The produced 3D display devices were evaluated as follows, using 3D glasses attached to W220S (by Hyundai) for the TN-mode liquid-crystal display devices, and using 3D glasses attached to 55LW5700 (by LG) for the VA-mode liquid-crystal display devices. The 3D display device K of Comparative Example 1 is the standard configuration (control) of the VA-mode liquid-crystal display devices; and the 3D display device I of Comparative Example 2 is the standard configuration (control) of the TN-mode liquid-crystal display devices. The results are shown in Tables 5 and 6.

### (1) Measurement of Front Brightness Ratio and Front Mean Brightness Ratio:

3D glasses and an indicator (BM-5A, by Topcon) were disposed at the front of the liquid-crystal display device that displays a stripe image of white and black stripes alternately aligned in the vertical direction, and the indicator was set on the side of the glass through which the white stripes could be visualized, and the front brightness A at the time of white level of display was measured. Subsequently, a stripe image in which the white and black stripes were reversed was displayed, and similarly, the indicator was set on the side of the glass through which the white stripes could be visualized, and the front brightness B was measured. The mean value of the front brightness A and the front brightness B is the front brightness of the 3D display device.

### (1-a) Front Brightness Ratio:

The front brightness ratio is a relative value of the front brightness in a case where the 3D glasses are parallel to the ground surface, and is computed according to the following formula.

Front Brightness Ratio of 3D Display Device (%)=front brightness of 3D display device/front brightness of control

### (1-b) Front Mean Brightness Ratio:

The front mean brightness ratio is a relative value of the front brightness mean value in a case where the 3D glasses are rotated, and is computed according to the following formula.

Front Mean Brightness Ratio of 3D Display Device (%)=front brightness mean value of 3D display device/front brightness mean value of control

### (2) Measurement of Viewing Angle Brightness Ratio and Viewing Angle Mean Brightness Ratio:

3D glasses and an indicator (BM-5A, by Topcon) were disposed at an azimuth angle of 0 degree and at a polar angle of 60 degrees to the liquid-crystal display device that displays a stripe image of white and black stripes alternately aligned in the vertical direction, and the indicator was set on the side of the glass through which the white stripes could be visualized, and the viewing angle brightness C at the time of white level of display was measured. Subsequently, a stripe image in which the white and black stripes were reversed was displayed, and similarly, the indicator was set on the side of the glass through which the white stripes could be visualized, and the viewing angle brightness D was measured. Further, the 3D glasses and the indicator were set at an azimuth angle of 180 degrees and at a polar angle of 60 degrees to the liquid-crystal display device, and the viewing angle brightness E and the viewing angle brightness F were measured also in the same manner as above. The mean value of the viewing angle brightness data C to F is the viewing angle brightness of the 3D display device.

### (2-a) Viewing Angle Brightness Ratio:

The viewing angle brightness ratio is a relative value of the viewing angle brightness in a case where the 3D glasses are parallel to the ground surface, and is computed according to the following formula.

Viewing Angle Brightness Ratio of 3D Display Device (%)=viewing angle brightness of 3D display device/viewing angle brightness of control

### (2-b) Viewing Angle Mean Brightness Ratio:

The viewing angle mean brightness ratio is a relative value of the viewing angle brightness mean value in a case where the 3D glasses are rotated, and is computed according to the following formula.

Viewing Angle Mean Brightness Ratio of 3D Display Device (%)=viewing angle brightness mean value of 3D display device/viewing angle brightness mean value of control

### (3) Lightfastness:

Using a lightfastness tester (Superxenon Weather Meter SX120 Model (long-life xenon lamp), by Suga Test Instruments), the display device was tested at a radiation dose of 100±25 W/m² (wavelength, 310 nm to 400 nm), at a temperature in chamber of 35±5 degrees Celsius, at a black panel temperature of 50±5 degrees Celsius, and at a relative humidity of 65±15%, according to JIS K 5600-7-5 for a lightfastness test time of 25 hours. Before and after the test, the change in the optical anisotropy of the retardation plate and the change in the polarization of the polarizing plate were checked. Tested devices of which the change ratio is within 10% are good; but those of which the change ratio is more than it are not good.

TABLE 5
Evaluation Results of VA-Mode Liquid-Crystal Display Devices

| | | | | Viewing | |
|---|---|---|---|---|---|
| | | Front | Viewing | Angle | |
| | Front | Mean | Angle | Mean | |
| | Brightness | Brightness | Brightness | Brightness | Light- |
| | Ratio | Ratio | Ratio | Ratio | fastness |
| Example 1 | 100 | 100 | 105 | 106 | not good |
| Example 8 | 100 | 100 | 105 | 106 | not good |
| Example 9 | 100 | 100 | 105 | 106 | good |
| Example 2 | 100 | 100 | 105 | 106 | not good |
| Example 10 | 100 | 100 | 105 | 106 | not good |
| Example 3 | 100 | 100 | 105 | 106 | not good |
| Example 11 | 100 | 100 | 105 | 106 | not good |
| Example 7 | 100 | 100 | 105 | 106 | not good |
| Comparative | 100 | 100 | 100 | 100 | good |
| Example 1 | | | | | |

From the above Table, it is understandable that the total of Rth in Comparative Example 1 is large and the viewing angle brightness reduction is larger than in Examples. In particular, it is understandable that in the embodiment of the VA-mode display, the total Rth of the members on the viewing side than the λ/4 layer (patterned optically-anisotropic layer of λ/4 film) is important for the viewing angle brightness. In other words, in general, the in-plane slow axis of the support is disposed to be perpendicular or parallel to the viewing side polarizing film, however, it is understood that, in the configuration of the type, Rth of the member (support) disposed between the λ/4 layer and the viewing side polarizing film is ineffective for the viewing angle brightness.

IPS-mode devices were also tested similarly to those VA-mode devices, and gave the same results.

TABLE 6
Evaluation Results of TN-Mode Liquid-Crystal Display Devices

| | | | | Viewing | |
|---|---|---|---|---|---|
| | | Front | Viewing | Angle | |
| | Front | Mean | Angle | Mean | |
| | Brightness | Brightness | Brightness | Brightness | Light- |
| | Ratio | Ratio | Ratio | Ratio | fastness |
| Example 4 | 100 | 100 | 124 | 127 | good |
| Comparative | 100 | 100 | 110 | 112 | good |
| Example 3 | | | | | |
| Example 5 | 100 | 100 | 124 | 127 | not good |
| Example 6 | 100 | 100 | 125 | 128 | not good |
| Comparative | 100 | 100 | 100 | 100 | good |
| Example 2 | | | | | |

From the data shown in above Table, it is understandable that the total of Rth in Comparative Example 2 and Comparative Example 3 is large and the viewing angle brightness reduction is larger than in Examples. In particular, it is understandable that, in the TN-mode devices differing from the VA-mode devices, Rth of all the members on the viewing side than the viewing side polarizing film has some influence on the viewing angle brightness.

Further, it is understood that the 3D display devices of Example 4 and Example 9 in which the support containing a UV absorbent is disposed on the outer viewing side than the patterned optically-anisotropic layer are improved in terms of the lightfastness, as compared with those of the other Examples in which the support containing a UV absorbent is not disposed on the outer viewing side than the patterned optically-anisotropic layer.

What is claimed is:

1. An optical film for 3D image display devices, comprising at least:
an optically-anisotropic layer formed of a composition that comprises, as the main ingredient thereof, a polymerizable liquid crystal, and
a polarizing film having an absorption axis in the direction at 45° to an arbitrary side, wherein
the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane,
the optically-anisotropic layer is disposed on one face of the polarizing film,
the total of retardation in-plane at a wavelength of 550 nm Re(550) of all the members including the optically-anisotropic layer disposed on one face of the polarizing film that are disposed in a domain corresponding to at least one of the first and second retardation domains is from 110 to 160 nm, and
the total of retardation along the thickness direction at a wavelength of 550 nm Rth(550) of all the members including the optically-anisotropic layer disposed on one face of the polarizing film is from −100 to 100 nm.

2. An optical film for 3D image display devices, comprising at least:
an optically-anisotropic layer formed of a composition that comprises, as the main ingredient thereof, a polymerizable liquid crystal, and
a polarizing film having an absorption axis in the direction at 90° to an arbitrary side, wherein
the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane;
the optically-anisotropic layer is disposed on one face of the polarizing film,
the total of retardation in-plane at a wavelength of 550 nm Re(550) of all the members including the optically-anisotropic layer disposed on one face of the polarizing film that are disposed in a domain corresponding to at least one of the first and second retardation domains is from 110 to 160 nm, and
the total of retardation along the thickness direction at a wavelength of 550 nm Rth(550) of the optically-anisotropic layer and all the members disposed on the opposite surface of the optically-anisotropic layer to the surface thereof on which the polarizing film is disposed is from −100 to 100 nm.

3. The optical film according to claim 1, wherein the in-plane slow axis of the first and second retardation domains and the transmission axis of the polarizing film are at an angle of ±45°.

4. The optical film according to claim 1, comprising, on the opposite surface of the optically-anisotropic layer to the surface thereof having the polarizing film thereon, a layer that contains a UV absorbent.

5. The optical film according to claim 1, wherein the polymerizable liquid crystal is a polymerizable rod-shaped liquid crystal.

6. The optical film according to claim 5, wherein the polymerizable rod-shaped liquid crystal is fixed in a horizontally-aligned state.

7. The optical film according to claim 1, comprising a polymer film of which retardation along the thickness-direction at a wavelength of 550 nm Rth(550) is from −200 to 0 nm, between the optically-anisotropic layer and the polarizing film.

8. The optical film according to claim 1, comprising an antireflection layer on the opposite surface of the optically-anisotropic layer to the surface thereof having the polarizing film thereon, and comprising, between the optically-anisotropic layer and the antireflection layer, a polymer film of which retardation along the thickness-direction at a wavelength of 550 nm Rth(550) is from −200 to 0 nm.

9. A 3D image display device comprising at least:
a display panel to be driven on the basis of an image signal, and
an optical film of claim 1 disposed on the viewing side of the display panel.

10. The 3D image display device according to claim 9, wherein the display panel comprises a liquid-crystal cell.

11. The 3D image display device according to claim 10, wherein the liquid-crystal cell is a TN-mode cell.

12. A 3D image display system comprises at least:
a 3D image display device of claim 9, and
a polarizing plate disposed on the viewing side of the 3D image display device, which visualizes a 3D image through the polarizing plate.

13. The optical film according to claim 2, wherein the in-plane slow axis of the first and second retardation domains and the transmission axis of the polarizing film are at an angle of ±45°.

14. The optical film according to claim 2, comprising, on the opposite surface of the optically-anisotropic layer to the surface thereof having the polarizing film thereon, a layer that contains a UV absorbent.

15. The optical film according to claim 2, wherein the polymerizable liquid crystal is a polymerizable rod-shaped liquid crystal.

16. The optical film according to claim 15, wherein the polymerizable rod-shaped liquid crystal is fixed in a horizontally-aligned state.

17. The optical film according to claim 2, comprising a polymer film of which retardation along the thickness-direction at a wavelength of 550 nm Rth(550) is from −200 to 0 nm, between the optically-anisotropic layer and the polarizing film.

18. The optical film according to claim 2, comprising an antireflection layer on the opposite surface of the optically-anisotropic layer to the surface thereof having the polarizing film thereon, and comprising, between the optically-anisotropic layer and the antireflection layer, a polymer film of which retardation along the thickness-direction at a wavelength of 550 nm Rth(550) is from −200 to 0 nm.

19. A 3D image display device comprising at least:
a display panel to be driven on the basis of an image signal, and
an optical film of claim 2 disposed on the viewing side of the display panel.

20. The 3D image display device according to claim 19, wherein the display panel comprises a liquid-crystal cell.

21. The 3D image display device according to claim 20, wherein the liquid-crystal cell is a VA-mode or IPS-mode cell.

22. A 3D image display system comprises at least:
a 3D image display device of claim 19, and
a polarizing plate disposed on the viewing side of the 3D image display device, which visualizes a 3D image through the polarizing plate.
